(19) United States
(12) Patent Application Publication
(10) Pub. No.: US 2026/0308773 A1
(43) Pub. Date: Oct. 8, 2026

(54) SCALABLE AUTOMATED OXYHYDROGEN-PRODUCTION, STORAGE, AND UTILIZATION SYSTEM

(71) Applicant: Enertopia Corp., Kelowna (CA)

(72) Inventors: Mark Snyder, Poway, CA (US); Terry Galyon, Magdalena, NM (US)

(73) Assignee: Enertopia Corp., Kelowna (CA)

(21) Appl. No.: 19/637,452

(22) Filed: Apr. 2, 2026

Related U.S. Application Data
(60) Provisional application No. 63/782,745, filed on Apr. 3, 2025.

(51) Int. Cl. C25B 1/044; C25B 9/63; C25B 15/023; C25B 15/08

(52) U.S. Cl. CPC C25B 1/044; C25B 9/63; C25B 15/023; C25B 15/085

(57) ABSTRACT

The system produces, stores, and utilizes Oxyhydrogen gas in scalable quantities for direct or indirect use in multiple applications where process automation and safety features provide continuous duty with a maximum level of safety and a minimum of maintenance. In an embodiment, the system generates Oxyhydrogen Gas using a generator/electrolyzer, a reservoir, a control module, a compression process, flash back arrestor with thermal indication, storage, safety release module, and a utilization burner module and/or a combustion module. In and embodiment There are an additional sub-systems and their components that support production including distilled water, caustic solution, heat exchange, vacuum pump, and De-Foamer.

This patent application claims priority to United States Provisional Patent Application 63/782,745 filed on Apr. 3, 2025, which is incorporated by reference herein in its entirety.

### BACKGROUND

Oxyhydrogen is a clean and sustainable fuel source that produces zero emissions, is renewable (uses water as a source), scalable, and can be generated in a decentralized manner. Oxyhydrogen is a mixture of hydrogen and oxygen gases, typically produced by the electrolysis of water, where electricity is used to separate water (H₂O) into hydrogen (H₂) and oxygen (O₂).

There are several disadvantages of the current methods of generating oxyhydrogen. One drawback of electrolysis is that it requires a significant amount of energy, typically more than the energy content of the hydrogen it produces. This makes it less efficient and costly unless renewable energy is readily available and cheap.

Electrolysis systems are still relatively expensive, particularly with current technology. The cost of electricity is a key factor in the overall cost of producing oxyhydrogen. While costs are dropping, they remain high compared to methods like steam methane reforming (SMR), which is commonly used for hydrogen production. Widespread adoption of oxyhydrogen production would require significant infrastructure investments, including renewable energy generation, electrolyzers, and storage solutions, especially if the production is decentralized.

Oxyhydrogen needs to be stored and transported in a controlled manner because both hydrogen and oxygen are highly flammable. Storing the two gases together increases the complexity, safety, and cost compared to storing them separately. Electrolysis depends on a consistent supply of water, which may not be available in areas with water scarcity. This could be a significant limitation in certain geographical locations. Over time, the electrodes used in electrolysis systems degrade due to the corrosive effects of oxygen and hydrogen. This can lead to decreased efficiency and increased maintenance costs.

Electrolysis efficiency is still relatively low, especially when compared to other hydrogen production methods. While advances in technology are improving efficiency, it is still not as energy efficient as other industrial hydrogen production methods.

### SUMMARY OF THE DISCLOSURE

The system produces, stores, and utilizes Oxyhydrogen gas in scalable quantities for direct or indirect use in multiple applications where process automation and safety features provide continuous duty with a maximum level of safety and a minimum of maintenance. The processed gas can be used in appliances, turbines, engines and generators, or equipment that requires a heat source. The system is designed to use in both stationary and mobile applications as needed.

In an embodiment, the system incorporates multiple integrated safety features across production, storage, and utilization stages to reduce the risk of gas accumulation, flashback, overpressure, and environmental contamination. Many components operate under vacuum or pressure conditions to prevent dangerous gas buildup. The generator is implemented as a dry cell configuration that reduces the presence of explosive gas near electrical connections. The reservoir system further enhances safety by removing atmospheric contaminants and improving gas separation. Multiple flashback arrestors, including an intelligent flashback arrestor with electronic sensors, are positioned throughout the system to detect and prevent flame propagation in both upstream and downstream directions, with automated shutdown responses initiated upon detection of a flashback event. Pressure relief valves, venting systems, and controlled purge operations are provided to manage overpressure conditions and safely dissipate gas when necessary. Additional safety features include automated sensor monitoring, real-time control by a centralized control module, moisture and impurity removal systems to stabilize the gas stream, and coordinated communication between system components to ensure safe startup, operation, and shutdown. Together, these features provide a layered safety architecture that enables continuous operation of the oxyhydrogen system with reduced risk of explosion, contamination, or system failure.

Power for this process can be provided directly from renewable energy, such as solar, wind, hydro etc. as DC power and off peak or excess grid capacity energy sources, which can be converted to DC power. Power can be provided by Hertzian Grid Power and transformed to DC power. In some embodiments, the system may also utilize non-Hertzian or scalar-type electrical energy sources. Such sources may include longitudinal or non-radiative electrical energy forms characterized by non-sinusoidal or direct-current waveforms, including steady-state DC fields or pulsed electrical signals generated through switching circuits or transformer-based systems. These energy forms may be captured, generated, conditioned, or converted into usable DC power for operation of the electrolysis process, either alone or in combination with conventional grid or renewable energy sources. The system may utilize singular or multiple components in parallel throughout the process in order to maximize production levels. In one embodiment, the system uses a proprietary electrolyte formula.

### BRIEF DESCRIPTION OF THE DRAWINGS

FIG. 1 is a block diagram illustrating an embodiment of a scalable automated oxyhydrogen production, storage, and utilization system.

FIG. 2 illustrates an embodiment of a plate-based generator or dry cell electrolyzer used to generate oxyhydrogen gas.

FIG. 3 illustrates an embodiment of a tube-based circular flow cell generator including concentric tubes used to produce oxyhydrogen gas.

FIG. 4 illustrates an embodiment of a reservoir system configured to separate electrolyte from produced gas and manage electrolyte circulation.

FIG. 5 illustrates an embodiment of a bubbler/cooler system used to wash produced oxyhydrogen gas and remove residual electrolyte.

FIG. 6 illustrates an embodiment of a desiccant dryer system used to remove moisture from the produced gas.

FIG. 7 illustrates an embodiment of an intelligent flashback arrestor configured to detect and prevent flashback events in the gas system.

FIG. 8 illustrates an embodiment of a high-pressure storage tank configured to store oxyhydrogen gas.

FIG. 9 illustrates an embodiment of a pressure relief valve associated with the storage tank.

FIG. 10 illustrates an embodiment of a point-of-usage control and purge valve used to regulate gas flow and purge the system.

FIG. 11 illustrates an embodiment of an electrolyte supply system configured to mix and deliver electrolyte solution to the reservoir system.

FIG. 12 illustrates an embodiment of an electrolyte recycling system used to manage used electrolyte removed from the system.

FIG. 13 illustrates an embodiment of a cooling system configured to regulate electrolyte temperature within the system.

FIG. 14 illustrates an embodiment of a moisture condensing system configured to remove moisture from the oxyhydrogen gas stream.

FIG. 15 illustrates an embodiment of a centralized controller system that monitors and controls the automated system.

FIG. 16 illustrates an embodiment of a multi-device distribution manifold.

FIG. 17A illustrates an embodiment of a zero compression oxyhydrogen engine.

FIG. 17B illustrates an embodiment of a zero compression oxyhydrogen engine with a fuel retaining valve.

FIG. 18 illustrates an embodiment of a steam generation system utilizing oxyhydrogen combustion.

FIG. 19 illustrates an embodiment of the steam generation system of FIG. 18.

FIG. 20 illustrates an embodiment of a burner system.

FIG. 21 illustrates an embodiment of a heat exchanger.

FIG. 22 illustrates an embodiment of a steam turbine.

FIG. 23 illustrates an embodiment of a turbine combined with a zero compression engine.

FIG. 24 illustrates an embodiment of a piston system driven by oxyhydrogen detonation.

FIG. 25 illustrates an embodiment of an ultrafiltration/RO system.

### DETAILED DESCRIPTION

This system may be implemented in an embodiment as an electrolyzer splitting hydrogen and oxygen from distilled or enhanced water H2O. The system may be implemented in an embodiment as a hydrogen and oxygen Generator splitting Oxyhydrogen Gas molecules from an electrolyte mixture of distilled or enhanced water and a Hydrogen Rich Element. The system may operate using distilled water alone or with an electrolyte or distilled or enhanced water with potassium hydroxide, sodium hydroxide or other hydrogen rich yielding elements as the source of the hydrogen and oxygen molecules created.

In an embodiment, the electrolyte solution includes water combined with an alkaline electrolyte to improve electrical conductivity during the electrolysis process. Suitable electrolytes include potassium hydroxide as a primary electrolyte and sodium hydroxide as an alternative electrolyte. The water component may include distilled water, deionized water, rainwater, melted snow, or other purified water sources. The electrolyte concentration may comprise any suitable range to achieve the desired results (for example, in one embodiment, the concentration may range from approximately—15 grams to 30 grams per gallon of water depending on the desired conductivity and system configuration). In an embodiment, the electrolyte solution operates within a pH range of approximately 12 to 14 (although other ranges and values may be utilized) and an electrical conductivity range of, by way of example, approximately 50 to 170 μS/cm. although other conductivity ranges may be used as desired.

The electrolyte solution may operate across a temperature range from, by way of example, approximately 0.56 degrees Celsius to approximately 60 degrees Celsius depending on system design and environmental conditions. Electrolyte degradation may occur due to heat, exposure to open air, time, or contamination within the electrolyzer system, and the electrolyte solution may be replaced periodically depending on system production levels and operating conditions. Additionally, catalysts, stabilizers and enhancers may be used such as aluminum etc. to increase production and or conductivity

This system will be described as a hydrogen/oxygen or Oxyhydrogen Gas generator, but in some cases may be utilized as an electrolyzer (for example, in the case of war, natural catastrophe or cataclysmic event if only distilled or enhanced water is available, Oxyhydrogen Gas could continue to be produced). There are some areas of the world that have been discovered that have naturally occurring hydrogen gas in the ground water from local mineralization. The system has embodiments that enhance the purity and energy value of the produced Oxyhydrogen Gas making it less costly to produce Oxyhydrogen Gas than a prior art Oxyhydrogen Gas electrolyzer/generator.

In an embodiment, the system implements a gravity fed hydrogen flow assisted dry cell where no pump is present. A reservoir is located above the cell so that the distilled water or Electrolyte can flow out of the lower outlet ports and into the bottom ports on the dry cell by tubing. The top outlet ports on the dry cell are connected with tubing to the ports above the outlet ports on the reservoir so that the Oxyhydrogen Gas and the distilled or enhanced water, or electrolyte can return to the reservoir in a continuous loop. In some embodiment's, a pump may be used to increase circulation when system size, or tubing length negatively affect flow.

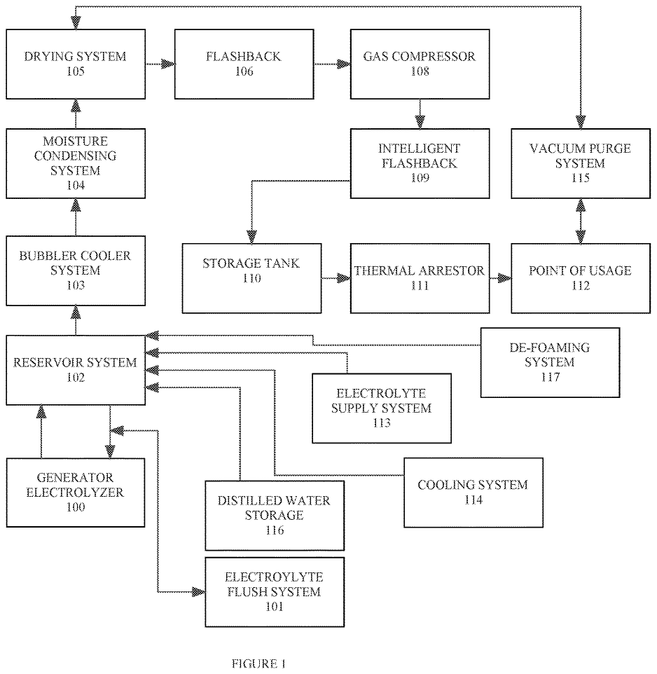

FIG. 1 is a block diagram illustrating an embodiment of the system for the Oxyhydrogen Gas electrolyzer/generation process utilizing the plate configuration. 100 receives energy (e.g., Direct Current in) for the operation of the system. Generator/Electrolyzer 100 provides gas and liquid mixture upwards to Reservoir System 102 and downward back to Generator/Electrolyzer.

In the downward path, an Electrolyte Flush System 101 transfers used electrolyte solution to a recycling system where it can be recycled into fertilizer, soaps, and the like.

In one embodiment, tubing or piping of adequate size may rely on gravity and thermally induced flow when Generataor/Electrolyzer 100 is positioned below Reservoir System 102. In an embodiment, fluid flow may be induced by a mechanical system such as a pump. Placing Reservoir System 102 below, or beside the Generator/Electrolyzer 100 allows unrestricted flow of gas and liquid through the Generator/Electrolyzer to the Reservoir.

In an embodiment, Reservoir System 102 includes one or more diffuser tubes and may include one or more separator diffuser plates. The Reservoir System 102 may have several inlets where diffuser tubes are installed inside the reservoir. The function of a diffuser tube is to allow emittance of small Oxyhydrogen Gas bubbles that reduces roiling of the combined gas and Electrolyte solution prior to additional gas separation processes.

There may be several parallel diffuser tubes in a manifold of the Reservoir System 102 depending on the size of the Generator/Electrolyzer 100. Each tube can have several hundred to several thousand 0.1 mm to 0.6 mm holes or perforations in a circumference around the tube. The diffuser tubes hole sizes, quantity, and locations can vary based on the system size and production requirements.

A perforated diffuser plate separator diffuser plate may be installed above the diffuser tube at a location that continues to reduce the roiling of the Oxyhydrogen Gas and electrolyte mixture as the gas passes through the Generator/Electrolyzer 100. Perforation hole sizes vary based on the designed throughput of the process. The lighter bubbles are drawn upward from the electrolyte mix by vacuum while the heavier bubble free electrolyte without Oxyhydrogen Gas condenses, settles and flows downward thru a return tube where it mixes again with the new makeup electrolyte and returns downward to the plate inlet.

Reservoir System 102 includes a De-Foaming system 117 with agent injection in an embodiment. Foam is created in the vessel from the electrolyte and the roiling nature of the process. An Electrolyte Supply System 113 supplies concentrated Electrolyte solution to the Reservoir System in an embodiment. Reservoir 102 is also coupled to electrolyte cooling system 114. The purpose of the Cooling System 114 is to maintain a proper range of temperature in the electrolyte effluent system.

Cooling capacity requirements may vary based on system size and environmental conditions. In some embodiments the cooling system may provide approximately 600 to 14,000 BTU per hour of cooling capacity per gallon of electrolyte solution when operating in ambient environments ranging from approximately 26.67 degrees Celsius to approximately 37.78 degrees Celsius. The cooling system may utilize a radiator, heat exchanger, or chiller configuration, and may circulate electrolyte or a secondary coolant such as polypropylene glycol through a heat exchange loop.

In an embodiment, the electrolyte solution is maintained within an operating temperature range that supports efficient gas production and reduces excessive vapor formation. The electrolyte temperature may typically range from approximately 23.89 degrees Celsius to approximately 60 degrees Celsius depending on system configuration and environmental conditions. In many embodiments a preferred operating range is approximately 26.67 degrees Celsius to approximately 51.67 degrees Celsius. Maintaining the electrolyte within this temperature range reduces excessive moisture formation in the produced gas and improves overall system stability and efficiency.

In an embodiment, there are sensors in the Reservoir System 102. They monitor for low solution liquid level, and for low Electrolyte level in the solution. Different automated system functions are activated and deactivated by the control module based off of the data sent to the Control Module by the sensors. In the event a Solution Liquid Low Level is detected from the sensors an AC or DC pump on the Distilled Water storage Tank 116 is activated to add water to the reservoir. In the event that a Low Electrolyte Level is detected from the sensors an Add Electrolyte Operation is activated by the Control Module and will bring the Electrolyte concentration level back to within normal operating parameters The Reservoir System 102 includes other sensors described below.

Above Reservoir System 102 is Bubble/Cooler 103, whose purpose is to separate residual electrolyte solution from the Oxyhydrogen Gas and to provide output to Moisture Condensing System 104. The Moisture Condensing System 104 is a condensing process except in this application the liquid that forms during the condensing process is a byproduct of the Oxyhydrogen Gas that is the main product. The Moisture Condensing System provides the Oxyhydrogen Gas to the Drying System 105.

In an embodiment, the Drying System 105 includes one or more Desiccant Dryers to remove remaining moisture or humidity from the produced gas. The Desiccant Dryers are equipped with moisture/humidity sensors located at the top by an output port. Dryers are mounted vertically in an embodiment to maximize performance and the efficiency. Multiple Desiccant Dryers are used by plumbing them in parallel with multi-port ac or dc valves on both the inlet and outlet side. In an embodiment, only one Desiccant Dryer is in use at any given time.

The output of the Drying System 105 is coupled to an inline flashback arrestor 106 configured to allow the Oxyhydrogen Gas to pass through it and into the storage tank using a specialized gas compressor 108. An Oxyacetylene gas compressor, or similar light gas compressor, modified for Oxyhydrogen Gas production may be used, for example. After the Drying System 105 the Oxyhydrogen Gas is dry and at a low pressure. The gas is now suitable for commercial or residential use and ready to be compressed into storage tanks. A commercially available gas sealed high pressure compressor 108 is utilized.

The output of the compressor 108 is coupled to Intelligent Flashback Arrestor (IFA) 109 which is able to prevent flashbacks in supply lines, both inbound and outbound directions. The output of IFA 109 is coupled to High pressure storage tank(s) 110. In an embodiment the system uses standard 1000 PSI or higher rated propane tanks that can be mounted vertically as shown, or horizontal. The output of storage tank 110 is coupled through either an IFA 109, or a thermal flashback arrestor 111, infrared sensor, or a specially designed laser temperature sensor on to point of usage valve 112. A sensor is tied into the control module to report any flashbacks. The Point of Usage Control and Purge Valve 112 is located at the very end of the system called the point of usage. Its purpose is to pull a vacuum on the entire system, and to remove atmospherics pollution or contamination to eliminate NOX and other pollutants.

Vacuum Purge System 115 is coupled to Point of Usage 112 and to Drying System 105. This system can be used as needed to provide complete vacuum in the system from Point of Usage 112 to Reservoir 102. Or, The Vacuum Purge System 115 may be used at startup to vacuum the production system in the event gas is present in the storage tank. It can activate valves to vacuum regenerate desiccant dryers in the Drying System 105 to purge internal systems before startup.

### Generator/Electrolyzer 100

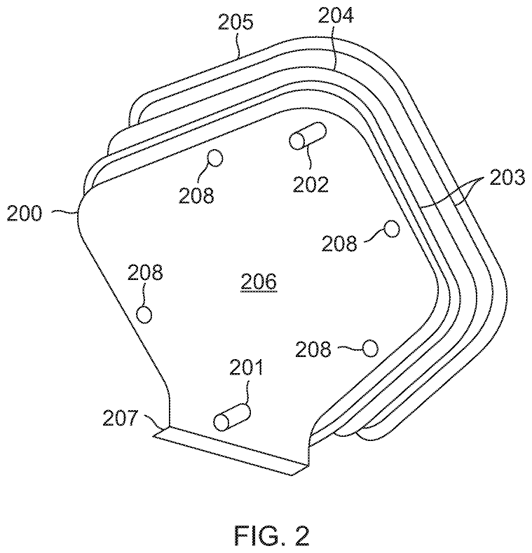

The Generator/Electrolyzer 100 is implemented in one of two ways in an embodiment. In an embodiment, the system uses a dry configuration Generator 200 as shown in FIG. 2. (Note, in a dry system the electrolyte or distilled, or enhanced water moves between plates or surfaces separated by a non-electrically conductive seal and the electrical connections to the electrolyzer are outside and dry, away from the explosive gas. In a wet system, the plates are submerged in the container).

The Generator 200 is made up of sandwiched plates in an embodiment. The Generator 200 includes End Bell Plates 206, Contact Plates 204, Floater Plates 205, and Spacer Gaskets 203. The plates or surfaces may be stainless steel, alloy steel, plated steel, or coated steel. The surface of plates may be pitted, sanded, or smooth. The electrolyzer oxyhydrogen/generator 200 may have multiple repeating series of plates. There are matching receiving holes 208 in each endbell plate for threaded insulated rod and securing nuts to run outside the Generator 200 to hold the plates and gaskets in place. Having the holes in the endbell plates results in greater surface area for the cells than in other designs.

The Generator 200 in an embodiment is configured to have a bottom point and a top point. Generator 200 may have an inlet 201 at the bottom and an outlet 202 at the top when positioned when as a rectangle with a top apex outlet and an inlet at the opposing diagonal location. In an embodiment, the Generator 200 is mounted in an upright position for maximum gas production through the apex. The physical size depends on process throughput. The orientation of the Generator 200 creates a stack affect.

In an embodiment, the Generator 200 includes an inlet 201 on both end plates that allows maximum flow of electrolyte or distilled, or enhanced water, or electrolyte mix with large, oversized diameter inlet port 201. An outlet 202 on both end plates allows maximum flow of electrolyte or distilled, or enhanced water, or electrolyte mix with large, oversized diameter outlet ports 202. The plates are separated by Gasket(s) 203 of a material that resists hydrogen and oxygen gas. For example, rubber, silicone, soft polymers or other materials resistant to our caustic electrolyte and hydrogen gas. In an embodiment, the gaskets are square and follow the outline of the plates.

The Generator 200 includes mounting feet 207 to stabilize and position the Generator 200. The generator can be mounted in an inverted fashion where mounting feet 207 are located on top, and outlet 202 becomes inlet 202, likewise, inlet 201 becomes outlet 201

End Bell Plates 206 serve several functions, including mounting, inbound and outbound effluent or Electrolyte flow connections, and as a de positive or negative Contact Plate depending on the requirements of the system. Contact Plates 204 serve as a positive or negative dc voltage connection points in an embodiment of the Generator 200. The number of Contact Plates 204 depends on the size of the Generator 200 and the power source that will drive the Generator 200, and the gas output required.

Floater Plates 205 serve as voltage dividers in the Generator 200. The number of Floater Plates 205 depends upon the amount of input drive voltage that is available for the Generator 200, which can range from less than 2 volts dc, up to thousands of volts dc.

Consider an embodiment at 12 VDC. In that system, there are two dc negative End Bells 206, one dc positive Contact Plate 204, and ten Floater Plates 205. In this configuration, the End Bell 206 negative, five Floater Plates 205, one Contact Plate 204, then another five Floater Plates 205, and then the last End Bell Plate 206 which would divide the voltage as follows starting from left to right 0-2-4-6-8-10-12-10-8-6-4-2-0 Where the center 12 is the Contact Plate with 12 volts de applied and the end 0 s are the de negative End Bells 206.

Some systems may work best with higher dc input voltages on the same number of plates. To run the Floater Plates at 3 volts the input voltage would be 18 volts dc and the divided voltage would therefore be 0-3-6-9-12-15-18-15-12-9-6-3-0.

On larger systems more Contact Plates 204 may be needed, and some will be positive contacts and some will be negative contacts. To preserve space and to simplify this example 6 volts dc is used as the drive voltage for the Electrolyzer where BOLD 6 indicates positive, and BOLD 0 indicates negative contact points. 0-2-4-6-4-2-0-2-4-6-4-2-0 .. It should be noted that the number of positive plates is not a set number, which means there may be one single positive contact point with outside negatives, or it could be many positives, and negatives configured as explained above to meet the production requirements of the end use device.

Spacer Gaskets 203 serve to seal around each plate in the Generator 200 and to provide the correct space between each plate (gap). The gap can range from small, such as 1 mm to several mm apart make a correct gap. Variances depend on voltage, electrolyte used and the amount of electrolyte, and type of material the Generator 200 is manufactured of or surfaces coated with.

Coating refers to the type of coating that may be on the surface of the plates such as Platinum, Titanium, Graphene, etc. that are known in the industry to produce higher amounts of Oxyhydrogen Gas than high grade stainless steel does by itself.

Depending on production needs, the End Bell 206, Contact 204, and Floater Plates 205 can vary in size from small, less than an inch square, to tens of feet in square all depending on input power required to drive the overall Generator 200 and its type of effluent or electrolyte. On small to medium size Generators 200, although generally square in shape, is designed to mount in a diamond fashion in an embodiment by the placement of the mounting feet 207 being situated on the corner of the End Bell 206 to utilize all available surface area of plates 204 and 205 by our thin gaskets 203 running along outer edge. The feet placement can be mounted down to a shelf or bracket, or mounted upside down on brackets secured from above.

The diamond shape created by corner located mounting feet create a higher flow output than traditional round gaskets found in other Generator 200 because of the increased distilled or enhanced water, or electrolyte/gas flow, and the extra surface area that can be included in the saturated area of the plates. Standard round gaskets do not include the point areas of the square shaped plates, thus reducing surface area. In addition, the large distilled or enhanced water, or electrolyte flow ports located at the bottom most area (inlet), and the topmost area (outlet) of the diamond shape provide maximum water/gas flow both to and from the reservoir The Dry cell design of the system is much safer and can be run at vacuum in a reservoir to prevent gas build up and explosions. This improves over a wet cell which collects explosive gas in an area where electrical connections are present. The present system offers more production due to better circulation of effluent or electrolyte, more square feet of production area resulting in higher output. The Generator 200 of the present system provides increased safety by elimination of gas buildup, and increased production by drawing the bubbles out of the liquid with the vacuum. In addition, inspection, maintenance and servicing of electrical and plumbing connections is made easier and more efficient.

In an embodiment, the Generator/Electrolyzer operates within a range of electrical and physical operating parameters depending on the desired gas production capacity and the configuration of plates or tubes within the cell. Input voltage supplied to the generator may range from approximately 12 volts DC to several thousand volts DC depending on the number of plate gaps and desired voltage per plate. In many embodiments the voltage potential across each plate gap is maintained between approximately 1.2 volts and 2.1 volts. Current draw depends on the size of the generator and electrolyte characteristics. In one experimental configuration using a generator having plates approximately twelve inches in size and operating at approximately 240 volts DC, the system produced approximately one liter of oxyhydrogen gas per approximately 0.80 amperes of current. Plate or tube spacing between adjacent electrodes may range from approximately 1 millimeter to 5 millimeters depending on electrolyte conductivity, applied voltage, and desired gas production rate. The rate of electrolyte flow through the generator may vary based on gas production rate and system configuration and may be driven by gravity circulation or by one or more pumps sized according to system production capacity.

In an embodiment, the electrodes of the generator are constructed from corrosion resistant conductive materials such as 316L stainless steel. Alternative materials may include alloy steels or other conductive metals resistant to hydrogen embrittlement. In some embodiments the electrode surfaces may include coatings or plating materials to increase catalytic activity and gas production efficiency. Example coatings include cobalt-molybdenum alloys, nickel, platinum, titanium, graphene, or similar catalytic materials. In other embodiments no coating is applied and the electrode surfaces develop an oxide layer through normal electrolysis operation.

### Generator 300

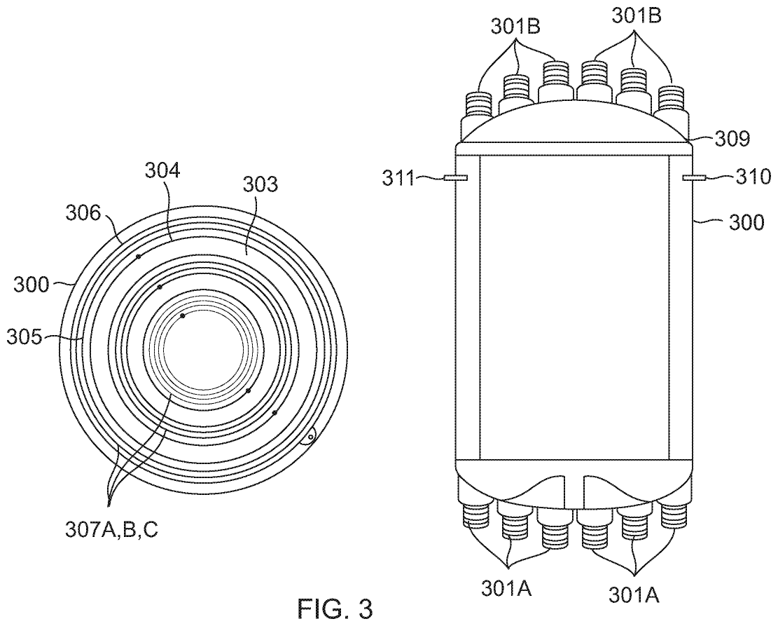

In an embodiment, Generator 300 is used instead of Generator 200. Referring now to FIG. 3, Generator 300 is a tube dry cell structure with a series of concentric cylinders defining arrays of cells. As with Generator 200, Generator 300 is a dry cell embodiment. The purpose of the circular dry cell Generator 300 is to convert the electrolyte that flows through it into an oxyhydrogen gas.

The circular flow cell Generator 300 is comprised of several tubes inside of each other in close proximity. The tubes are configured in different ways depending on the electrolyte used, or the voltage of a given power source. Circuits or Arrays 307 A, B, C of tubes are wired accordingly based off of the varying parameters. A positive contact point/s/tube/s 304 will be located between a variable quantities of Floater Tubes 305 before coming to a negative tube 306.

Because the surface area grows as the tubes increase in diameter the spacing of the positive 304 and negative 306 contacts is variable throughout the array as shown in FIG. 3. The tubes located between the positive and negative contact tubes are floater tubes 305, which serve as voltage dividers in the cell. The number of floater tubes 305 will vary throughout the cell.

Energy to drive the cell can vary depending on the location of the positive 304 and negative 306 contacts and the electrolyte used; however, an example embodiment is shown in FIG. 3. Voltage to drive the Circular passive flow cell Generator 300 can range from 1.4 to 2.4 V dc based on the configuration and the amount of tubes.

For example, the tubes may be configured as follows from center to the outer contact tube. Center negative 306, followed by four floater tubes 305, then a positive tube 304, followed by only two floater tubes 305 due to the increased surface area of the tubes beyond the positive contact and variation in positive and negative contact location and floater plate amount based on length of tube, diameter of tube, and electrolyte used and the amount used.

Tube Spacer Frames are used in the top and bottom of a circular flow cell Generator 300 to hold the tubes in place and assist in a smooth flow of distilled or enhanced water, or electrolyte solution from the middle inlet to the outside area on the bottom. Due to the mirror effect the top Tube Spacer Frame will reverse the flow from the outer area back to the center area on the top (On a system with a single top and bottom inlet). Other systems may be configured with multiple inlets and outlets as shown in FIG. 3.

In an embodiment, the Generator 300 includes non-conductive material 303 to fill and block off the area between active tubes to manage the distilled or enhanced water, or electrolyte flow through the active tubes only. This design can have single flow or multiple flow patterns of the distilled or enhanced water, or electrolyte solution based on the output requirements.

The Tubing spacers Top and Bottom can also be made in a solid ring or an X pattern. The solid ring on the bottom will have flow paths from the center inlet port, out to each active array which creates a flow of distilled or enhanced water, or electrolyte from the center bottom inlet outward, and on the top it would bring the flow from the outer active arrays back to the center and out the outlet port.

In an embodiment, the tubes are made from high grade stainless steel such as 316L. The tubes can be coated with other metals which are known in the industry to produce greater output of gas such as Platinum, Titanium, and Graphene as an example.

The circular flow cell Generator 300 is a cylindrical shaped vessel which has a distilled or enhanced water, or electrolyte port/s on the bottom 301A to allow distilled or enhanced water, or electrolyte to enter and fill the vessel, and an outlet distilled or enhanced water, or electrolyte port/s on the top 301B where gas filled distilled or enhanced water, or electrolyte exits the vessel. The tubes are held in place by the Spacer Frames in the top and bottom of the vessel. And the tubes themselves are connected to the external DC power system through the positive 311 and negative 310 contact points.

This design has increased output because of the constant flow of fresh distilled or enhanced water, or electrolyte entering the inlet tube on the bottom and forcing the upward flow of the Oxyhydrogen Gas bubbles that form on the tubes from the electrolysis process. Cleaning is also easier with this design because the removable lid comes off to expose the contact wires and the top Spacer Frame which can be lifted out of the way to get to the tubes, which can be raised by removal tabs to clean and replace.

There are other type of tube in tube designs out there that are submerged into a reservoir where the distilled or enhanced water, or electrolyte is held. Such systems have a disadvantage of possible buildup of explosive gas in the same area where wire and electrical current is present. The circular flow cell Generator 300 although is a tube in tube design it is completely flooded with electrolyte which does not allow for the accumulation of explosive gas in the area where electrical contacts and current is present.

The present Dry cell design is safer and can be run at vacuum in a reservoir to prevent gas build up and explosions. Whereas a wet cell collects explosive gas in an area where electrical connections are present. The system also allows more production due to better circulation of effluent or electrolyte, and more square feet of production area resulting in higher output with a smaller footprint.

Generator 300 also has advantages of increased safety by elimination of gas buildup, and increased production by drawing the bubbles out of the liquid with the vacuum. Much easier to scale, much easier to clean by using integrated lift tabs and higher output and lower operating cost.

### Reservoir System 102

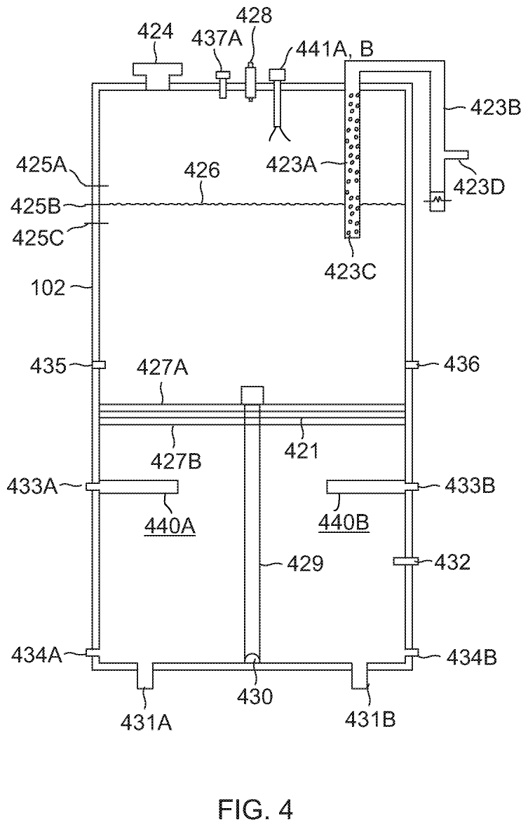

FIG. 4 illustrates the Reservoir System 102 and related components in an embodiment. The Reservoir System 102 functions as an Electrolyte Management and Gas Separating System. Referring now to FIG. 4, the Reservoir System 102 can be made of various materials such as schedule 80 PVC, or other polymers, high grade stainless steel, plated metals and the like, which are corrosion and hydrogen embrittlement resistant. The Reservoir System 102 operates in a vacuum in order to eliminate nitrogen and atmospheric pollution in the production gas.

In an embodiment, the Reservoir System 102 may operate under vacuum or slight positive pressure depending on system configuration and elevation. Typical operating pressure within the reservoir may range from approximately −28 PSI vacuum to approximately +15 PSI. Maintaining a controlled vacuum assists in drawing gas bubbles upward from the electrolyte solution and improves separation of Oxyhydrogen Gas from the electrolyte mixture while reducing atmospheric contamination. The Reservoir System 102 retains the Electrolyte solution and utilizes several safety features from communication of sensors and probes to the Control Module.

In one embodiment, Reservoir System 102 is comprised of Separating Plate 421, Moisture Reduction Cartridge 423A, Outlet Tube 423B, Moisture Reduction Medium 423C, Gas Outlet 423D, Fill Cap 424, sensors 425A, B, and C that monitor the Electrolyte in the reservoir. The system includes Electrolyte Solution Level 426, Upper and Lower Retaining Rings 427A and 427B for the Separating Plate.

The Moisture Reduction Cartridge (MRC) 423A is the next step in separation of the gas to reduce moisture In an embodiment, it is threaded so it can be screwed in or screwed out for easy removal. The Cartridge 423A is made of a corrosive resistant material such as PVC, nylon, stainless steel etc. At least one is used per reservoir. The MRC is screwed into the top of the reservoir and is the outlet for the moisture. The outer walls and bottom are filled with small holes to allow for a nonrestrictive flow of Oxyhydrogen Gas from the inside the reservoir to the inside of the MRC. The Oxyhydrogen Gas flows upward through the inside of the MRC which is filled with a moisture gathering materiel such as nylon or sintered metal.

The MRC works as follows. The Oxyhydrogen Gas that is bubbling up through the electrolyte is at a very high humidity level and creates splashing of water bubbles at the top of 102. Before he Oxyhydrogen Gas passes from the reservoir and through the outer portion of the MRC outside the reservoir it is introduced to a moisture gathering materiel such as nylon or sintered metal which by way of friction collects some of the humidity and all the water splash in the Oxyhydrogen Gas as it moves up and out the outlet port and moves on to the Moisture Condensing Phase through the exit port 423B. The electrolyte that condenses in the MRC drops back down into the reservoir. The MRC stops bubble splash from entering the exit port. It reduces humidity and reduces electrolyte exiting the Reservoir. It preserves Electrolyte and Distilled Water and reduces the cost of producing the gas.

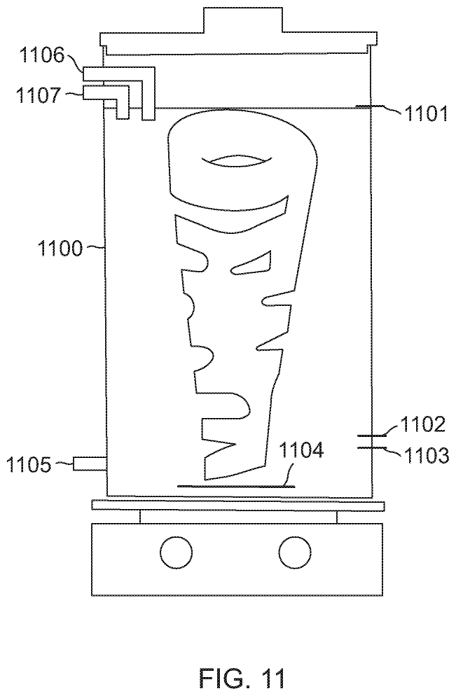

Electrolyte De-Foamer Spray injector 428 is coupled to a De-Foamer tank 117 (which is the same embodiment used in FIG. 11 as the Concentrated Electrolyte supply 1100). The De-Foamer tank 117 is a vessel made of a corrosive resistant material such as PVC, or Acrylic, and serves as the storage tank for the De-Foaming solution in an embodiment. In one embodiment, it is a flat bottom tank so that a magnetic stirrer can be used to keep the De-Foaming solution well mixed, and it has a removable (sealed) lid so more De-Foaming solution can be added as needed, it also has a small push button style vacuum release port located on the lid, or top portion of the tank to release the suction that builds inside the defoamer tank for maintenance.

The Reservoir System 102 includes an AC or DC Electrolyte De-Foamer Sensors 441A and 441B that are monitored by the control module to sense the accumulation of foam in 102. In the event foam is detected, an AC or DC pump attached to the outlet line from the De-Foamer tank 117 provides the pressure necessary to push the solution through the De-Foamer Spray injector 428 on the top of the reservoir. Outlet port 431A leads to Electrolyte Cooling System 114 and Inlet port 431B returns from Electrolyte Cooling System 114. The Reservoir 102 includes temperature Sensor 432, inlet ports 433A and 433B from Generator/Electrolyzer 100, and outlet ports 434A and 434B to Generator/Electrolyzer 100, Distilled Water inlet Valve 435, Concentrated Electrolyte Injector 436, and Purge Vent 437A. (Note, Vessels that utilize the Separator Plate 421 can be used in mobile applications such as on a trailer for remote use because Separator Plate 421 acts as an anti-splash guard) as well as a gas cleansing process.

Inlet ports 433A and 433B are coupled to one or more diffuser tubes 440A and 440B. The function of a diffuser tube is to allow emittance of small Oxyhydrogen Gas bubbles that reduces roiling of the combined gas and Electrolyte solution prior to additional gas separation processes. In an embodiment, the diffuser tubes are configured to produce bubbles having a diameter of approximately 0.1 millimeters to 1.5 millimeters at the point of release from the diffuser holes. Smaller bubble sizes increase surface interaction between the gas and surrounding liquid, which improves cooling and cleaning of the gas and reduces splashing and carryover of electrolyte droplets toward the upper separation stages. (diffuser tubes increase the probability of pump/s to be used between the Reservoir and the Electrolyzer)

There may be several parallel diffuser tubes in a manifold depending on the size of the electrolyzer/generator 100. Each tube can have several hundred to several thousand 0.1 mm to 0.6 mm holes or perforations in a circumference around the tube. The diffuser tubes hole sizes, quantity, and locations can vary based on the system size and production requirements. The reduction in bubble size makes for a smoother transition from a liquid wet gas to a dryer gas. It also decreases splashing in the Reservoir System 102 to allow for a dryer gas. The diffuser tube assembly may be used in other parts of the system such as in the bubbler cooler 103 or anywhere Oxyhydrogen Gas is emitted into a liquid.

Separator plate 421 defines a second step in separating Oxyhydrogen Gas bubbles from the electrolyte mixture. The liquid Return tube 429 (shown rotated 90 degrees out of phase directs flow of the heavy gas free solution towards outlet ports 434A & 434B to increase flow. The electrolyte De-Foamer sensors 441A & 441B that are mounted on the top of the reservoir are monitored by a control module for a drop in Ohms. When this drop occurs the control module activates and adds De-Foamer solution to the process. An AC or DC pump attached to an outlet line from the De-Foamer tank provides the pressure necessary to push the solution through the injector on the top of the reservoir.

The injector 428 on the top of the reservoir is either an ac or dc type injector or valve and is controlled by a Control Module. In an embodiment, the Control Module may comprise a programmable logic controller, an embedded computer, a network server, an industrial computer, or a single-board computer platform. The Control Module monitors sensors and controls system components including pumps, valves, compressors, heaters, dryers, and other subsystems throughout the oxyhydrogen production system. The Control Module may be configured to perform system startup, shutdown, purge operations, safety monitoring, data logging, and automated adjustments to system parameters including production rate, electrolyte concentration, liquid levels, and system health. The Control Module may communicate with system components and sensors using wired or wireless communication protocols. Example communication methods may include USB, Ethernet, Wi-Fi, fiber optics, RS-232, RS-485, Modbus, TCP/IP, UDP, and other industrial communication protocols depending on the configuration of the production system and the scale of the installation. Sensors 425A, 425B, 425C are located on the upper level of the Reservoir System 102

This Reservoir System 102 does more than simply hold the electrolyte solution. With its many sensors and accompanying components, it is a state of the art oxyhydrogen separator that provides automatic Water level, automatic Electrolyte mix levels, automated cooling system for the Electrolyte Solution, automatic defoaming system for longer use of Electrolyte mix, the ability to be used in Mobile Environments, and dryer/cleaner Oxyhydrogen Gas.

In an embodiment, there is a significant increase in efficiency-by keeping the Reservoir System 102 in a vacuum state during production. The vacuum environment also provides a purer gas from the initial startup because of the removal of Nitrogen and Atmospheric Oxygen from the system.

### Bubbler/Cooler System 103

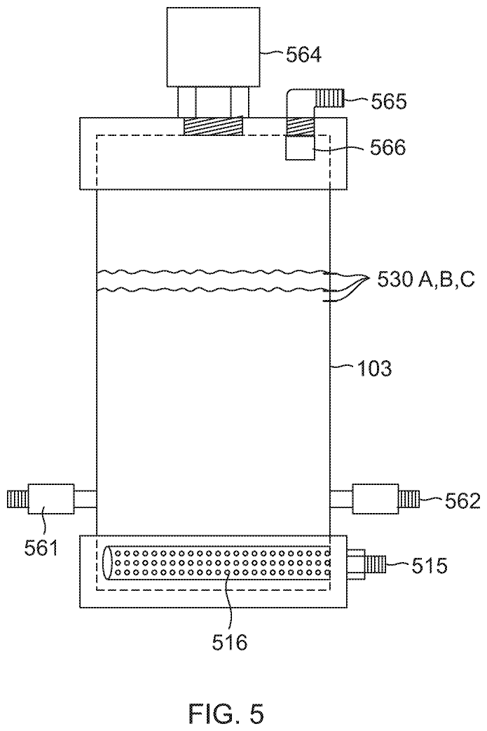

The Bubbler/Cooler System 103 is illustrated in FIG. 5. The purpose of the Bubble/Cooler is to separate residual electrolyte solution from the Oxyhydrogen Gas after it passes through the moisture reduction cartridge 423A at the top of the reservoir 102.

In an embodiment, the Bubble/Cooler 103 is made of a cylinder that is made of a dense plastic such as thick walled PVC, thick walled Acrylic that can be clear to allow for viewing of the gas as is works its way from the bottom to the top. Larger systems use a suitable alloy metal in an embodiment.

There is a threaded inlet 515 that is located at the bottom. The inlet is directly attached to a diffuser tube 516. The diffuser tube 516 in an embodiment is a small tube that is covered with tiny holes (example 0.1 mm, 0.2 mm, 0.3 mm, 0.4 mm, 0.5 mm to 0.6 mm in diameter) or wintered metal, the amount of holes being dependent upon the type of material used to make the diffuser tube 516. The number of holes depends upon the volume of gas being run through the diffuse tube. The designed result is zero restriction in flow through the small holes. Having smaller bubbles allows the gas to come out extremely small, and that makes it easier to wash and cool compared to larger bubbles.

In an embodiment, the diffuser tube emits tiny bubbles that rise up from the bottom creating a curtain of bubbles that serve to break the produced gas down into smaller blocks to be cooled and separated from the electrolyte. Located on the bottom area, as low as possible in the sides of the Bubble/Cooler 103, is at least one port 561 with an electrically controlled flush valve. The water that is released during a flush will be sent to an ultrafiltration system or R/O System to remove impurities to be used again, or sent to a storage tank to be used for other purposes such as fertilizers or the making of soap,

A fill valve 562 is installed to maintain a full water level and is controlled by the Control Module. In the upper area of the Bubble/Cooler 103 are the Control Sensors 530A, B, and C. The sensors are located in the upper area of the Bubble/Cooler 103 and are used to monitor and maintain the liquid level in the Bubbler/Cooler 5103. The top sensor 530 A communicates to the Control Module that the Bubble/Cooler is low on water, or full. The bottom sensor 560C is the reference sensor that communicates with both the top and the middle sensor 560B through the Control Module to activate a flush process as needed, and to maintain water at maximum levels.

At the top area of the Bubble/Cooler 103 is the outlet port 565 with an MRC 566 that includes moisture reduction medium on its inlet that sends the gas to the next stage of the process. Also located at the top of the Bubble Cooler is a Pressure Release Port 564. The purpose of the Pressure Relief Port 564 is to protect the Bubble/Cooler 103 from being over pressured in the unlikely event of a flashback.

The Bubble/Cooler 103 has a number of advantages over prior art systems, including the use of the flush/level/condition sensor and the diffuser tube 516 and MRC. The Bubbler/Cooler System 103 provides cleaner gas and an additional layer of safety for Reservoir System 102.

The Bubbler Cooler takes the Oxyhydrogen Gas from the MRC 423A and runs it through the diffuser tube 516 in the bottom of the Bubbler/Cooler 103 which turns the Oxyhydrogen Gas into a fine wall of tiny bubbles. This process washes the Oxyhydrogen Gas to remove impurities. As the Oxyhydrogen Gas bubbles burst in the top of the Bubbler/Cooler System 103 into the next phase of the process which is the moisture condensing phase using the Desiccant Dryers.

### Moisture Condensing System 104

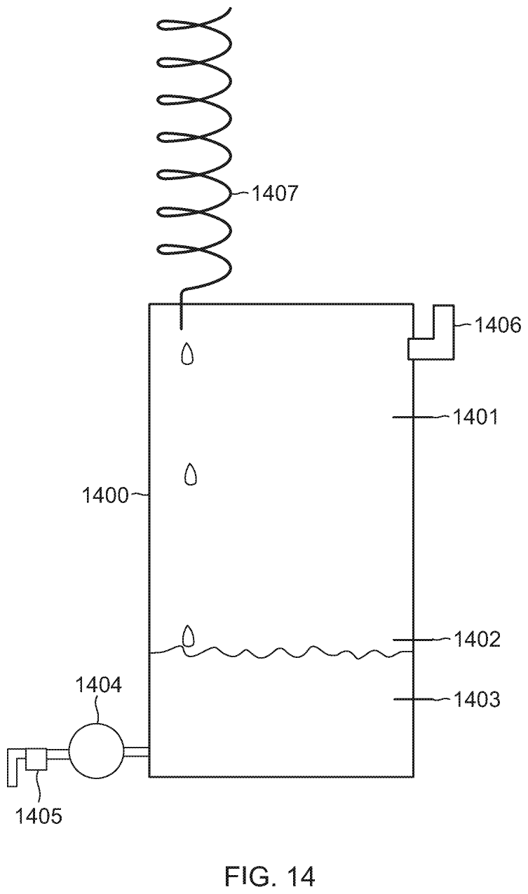

The Condensing System 104 includes a Moisture Condensing System shown in FIG. 14. The Moisture Condensing System is a Condensing process. In an embodiment, the liquid that forms during the condensing process is not the final product but instead is a byproduct of the Oxyhydrogen Gas that is the main product. The condenser is made up of tubing 1407, a water collection tank 1400 which also serves as an Oxyhydrogen Gas passage out to the next stage.

The Oxyhydrogen Gas cools as it passes through the non-corrosive tubing 1407, and as it does Electrolyte is collected on the walls of the tubing and that electrolyte drips down out of the tubing in the form of water droplets and they land in the collection tank 1400 at the bottom of the tubing.

As the electrolyte that is collected in the collection tank rises it will make contact with a set of Sensors 1401 start sensor, 1402 stop sensor, and 1403 common sensor that are monitored by the Control Module. When the collected Electrolyte reaches the top sensor 1401 the Control Module will activate an ac or dc pump 1404 that will purge the collection tank of electrolyte until the electrolyte level drops below sensor 1402. This water will be pumped through an ac or dc valve 1405 and back into the reservoir from which it came through tubing routed back to the Reservoir System 102.

The collection tank 1400 is also where the cool dry Oxyhydrogen Gas enters from the condensing tubing and then exits through the outlet port 1406 in the top area of the collection tank. On larger systems where the Oxyhydrogen Gas is produced and higher temperatures are produced, a water cooled outer jacket will be needed over the condensing tube 1407 to more rapidly cool the gas and force the condensing of Solution Mix.

### Drying System 105

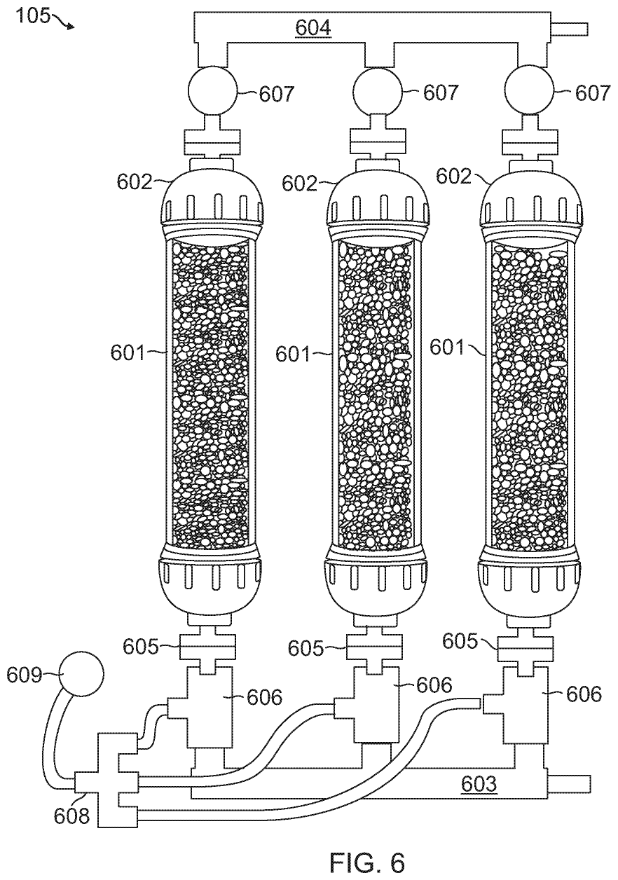

The Drying System 105 includes specially designed Desiccant Dryers 601 that are equipped with moisture/humidity sensors located at the top by the output port, as shown in FIG. 6. Dryers are mounted vertically to maximize performance and the efficiency. Multiple Desiccant Dryers are used by plumbing them in parallel with multi-port ac or dc valves on both the inlet and outlet side. In an embodiment, only one Desiccant Dryer is in use at any given time. After the desiccant dryer, the Oxyhydrogen Gas is dry and at a low pressure. The gas is now suitable for commercial use and ready to be compressed into storage tanks.

The Purpose of the Desiccant Dryer system 105 is to remove remaining moisture or humidity from the produced gas. In an embodiment, the desiccant material used within the Desiccant Dryer system 105 may include silica gel or other moisture-absorbing materials capable of removing humidity from the produced gas stream. The dryers may be regenerated by placing the desiccant medium into a high vacuum environment that lowers the boiling point of water contained within the desiccant. For example, under approximately −28 PSI vacuum at sea level, water may begin to vaporize at approximately 15.56 degrees Celsius, enabling rapid removal of moisture from the desiccant material. Regeneration temperatures may range from approximately 15.56 degrees Celsius to approximately 82.22 degrees Celsius depending on the vacuum level and system configuration.

The specially designed Desiccant Dryers 105 are equipped with moisture/humidity sensors 602 located at the top by the output port on each dryer module 601. Dryers 601 are mounted vertically to maximize performance and the efficiency. Multiple Desiccant Dryers are used by plumbing them in parallel through inlet manifold 603 and outlet manifold 604 which are equipped with quick disconnect unions 605 on top and bottom of each dryer module 601 for easy maintenance if needed. In one embodiment, only one Desiccant Dryer 501 is in use at any given time.

In addition to the moisture/humidity sensors 602 there are electronic inlet valves 606 and electronic outlet valves 607 on each Desiccant Dryer 601 that are opened and closed by the Control Module. These are multi-port valves that have two states of operation, a vacuum mode, and a gas flow mode. In gas flow mode a single Desiccant Dryer 601 is in use and allows the produced gas to pass through its medium inside, all other remaining Desiccant Dryers 601 in the system are in vacuum mode isolated from the produced gas system and are pulled down to a full vacuum state by the Vacuum Pump 609 which is controlled by the Control Module. The purpose of the vacuum pump 609 is to remove moisture and air in the medium via Manifold 608 and to keep the dryers in a ready to use state.

After the Desiccant Dryers 601, the gas is passed via an inline Flashback Arrestor 106 to a Gas Compressor 108. A flashback arrestor is a critical gas safety device used in oxyhydrogen systems to prevent dangerous flashbacks (where flames travel backward into hoses, regulators, or cylinders) thereby stopping explosions and protecting equipment. In an embodiment, the Gas Compressor 108 is a specialized reciprocating commercial gas compressor. In various embodiments, the Gas Compressor 108 may include explosion-proof compressors, helical screw compressors, diaphragm compressors, piston compressors, reciprocating compressors, ionic liquid compressors, or scroll compressors depending on the system size and operating requirements. The compressor may operate with a vacuum condition on the inlet side and may compress the produced gas to pressures suitable for storage within the storage tank. Typical operating pressure ranges may extend from vacuum conditions on the inlet side to approximately 50 PSI to 1000 PSI or higher depending on system design and the pressure rating of the storage tank.

The compressor flow rate is typically selected to match the gas production rate of the generator system so that gas accumulation does not occur upstream of the compressor. Some high pressure storage systems may require 2 pumps in order to maintain a vacuum in the reservoir 102. In an embodiment, safety shutdown conditions may include over-temperature conditions, over-pressure conditions, compressor failure to start, or inability to achieve the required storage pressure, any of which may trigger a full system shutdown controlled by the Control Module.

An oxyacetylene type gas compressor, or similar light gas compressor, modified for Oxyhydrogen Gas production may be used, for example. After the desiccant dryer, the Oxyhydrogen Gas is dry and at a low pressure. The gas is now suitable for commercial or residential use and ready to be compressed into storage tanks. A commercially available gas sealed high pressure compressor is utilized. On the inlet and outlet side of the compressor are sensors that monitor gas flow. The outlet of the Compressor Tank 108 is provided to Intelligent Flashback Arrestor 109 before proceeding to a Storage Tank 110.

Each Dryer that is deactivated for saturation is automatically dried by the Desiccant Dryer Recovery System which in an embodiment, pumps hot dry air from the top of the Descant Dryers output port through to the bottom inlet port making it ready for use again. This process lowers operating cost and maximize the desiccate medium.

### Intelligent Flashback Arrestor (IFA) 109

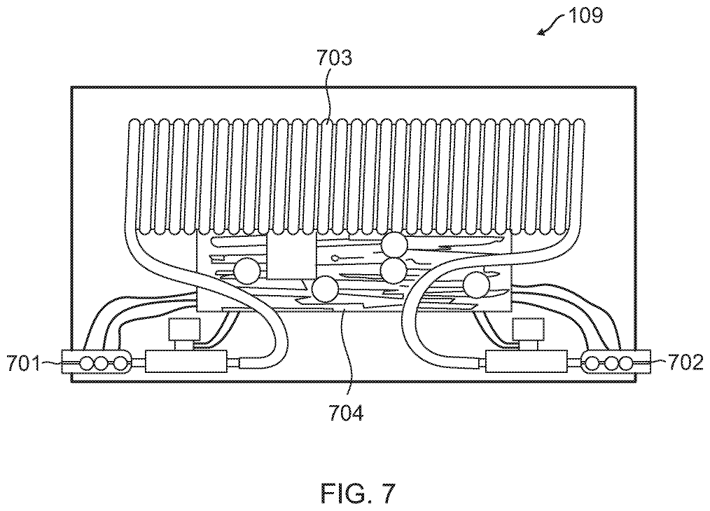

The IFA 109 is illustrated in FIG. 7. In an embodiment, the Intelligent Flashback Arrestor (IFA) 109 detects flashback conditions electronically using one or more sensors capable of identifying rapid combustion events within the gas flow path. Suitable sensors may include ultraviolet sensors, infrared sensors, optical light sensors, temperature sensors, laser sensors, pressure sensors, photodiodes, phototransistors, or light dependent resistors configured to detect the presence of flame, heat, or rapid pressure changes associated with a flashback event. These sensors may produce voltage, resistance, pulse, digital, or analog signals that are interpreted by the IFA processor to determine whether a flashback condition exists.

Detection timing may depend on the response characteristics of the sensors used and may range from nanoseconds to milliseconds depending on the sensing technology. Upon detection of a flashback condition the IFA may immediately initiate a shutdown response by sending commands to one or more valves to close open flow paths and isolate sections of the gas system. In stand-alone configurations the IFA may close all connected valves and await manual reset, while in integrated production systems the response may vary depending on the location and severity of the detected flashback event and may include temporary shutdown of a subsystem, notification to operators, or complete system shutdown controlled by the Control Module.

The IFA 109 is able to prevent flashbacks in supply lines, in both inbound and outbound directions, depending on single valve or double valve configuration by a collection of sensors 701 or 702 which are high temperature sight glasses with sensors utilizing various forms of sensor technologies, such as UV, Ambient Light, Laser, or other light/heat sensing technology that can be located on both the inlet and outlet of the IFA 109. Flashbacks can be prevented even under high pressure where a positive flow from a pump to a storage vessel can be shut down to prevent the flashback from reaching the pressurized vessel, by utilizing a Time Altering Technology and an onboard processor 704. The Time Altering Technology combines physical structure (e.g., coil 703) and sensors to delay the Oxyhydrogen burn rate so that the shutoff valve can have time to actuate. Burn rates can range from 1,700 to 3,000 M/s. Without the Time Altering Technology, the system would not be able to detect and prevent a flashback from getting though before shutting the valve. In an embodiment, the Time Altering Technology uses light/heat/laser sensors, and tubing length and diameter based on the volume and pressure of the Oxyhydrogen gas that passes through the IFA 109. On larger systems, or systems that run at higher pressures more sight glass sensors, different diameters of tubing, different lengths of tubing, tubing split into multiple sections of varied sizes, along with varied sensors can be used to determine and prevent flashbacks. This technology is designed using a standalone computer, sensors, lasers, relays, switches, valves, and software codes.

In an embodiment, there is gas in the coil between 701 and 702. If there is a flashback and the gas explodes, the pressure instantly rises throughout the coil, which slows the flame down before it reaches the other side. That allows the valve time to shut off and protect the rest of the system.

The IFA 109 provides information to maintenance and safety personnel through the built in Modbus communication in the event a flashback were to occur so that appropriate measures can be taken. Although the IFA is a standalone system, and can be powered by AC or DC input to the power connector so it can be implemented anywhere in the Oxyhydrogen Gas system, and it can be connected to the Control Module VIA USB, LAN, or RS 485 Shielded Cabling 320C, using mod-buss registers and protocol, or wireless communication. This can be beneficial in identifying a reoccurring problem in the system. The IFA 109 provides a number of advantages over prior art systems. The IFA 109 is electronic instead of manual/mechanical, promotes safety, raises efficiency, works in low or high pressure applications, has bi-directional flashback detection, reduces back pressure in supply lines, reduces pump size, by providing a freer flow of gas, provides a digital trail for trouble shooting and management, and provides a communication protocol Compatible with industry standards such mod-bus 485 or evolving industry standards.

### High Pressure Storage Tank 110

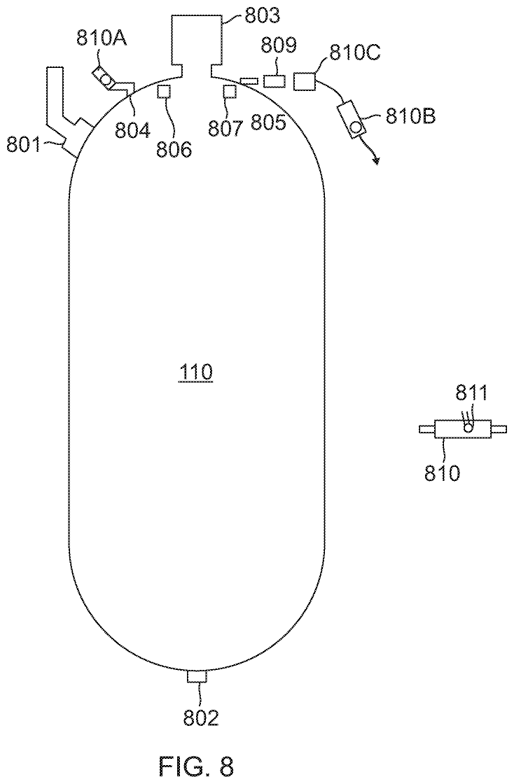

The high pressure storage tank 110 is shown in FIG. 8. In an embodiment, the system uses standard 1000PSI or higher rated propane tanks that can be mounted vertically as shown, or horizontal. In an embodiment, storage pressure within the storage tank may vary depending on the application and tank rating. Typical operating storage pressures may range from approximately 50 PSI to approximately 3000 PSI depending on the design of the system and the structural integrity of the storage vessel. Storage tanks may be constructed from materials such as stainless steel, steel, or carbon fiber reinforced composite pressure vessels capable of safely containing compressed oxyhydrogen gas. Practical tank sizes may range from approximately five gallons for smaller systems to several thousand gallons for larger industrial installations.

In an embodiment, a vent release system may be configured to activate when pressure exceeds a predetermined threshold. The vent release threshold may be set at approximately 10 percent to 30 percent above normal operating system pressure or approximately 5 percent to 15 percent below the full rated pressure of the storage tank. Venting may also occur in response to external safety conditions such as detection of fire near the storage area or other hazardous environmental conditions.

In the case of horizontal all the fixtures would be mounted on the top in an embodiment. As tanks get larger higher-pressure ratings will be required. The tanks are outfitted with a novel Oxyhydrogen Gas storage tank flash and fire prevention vent system. The management and fire prevention system is tied into internet, GPS monitoring, weather station, and an infrared detection system that can identify a fire coming towards the tank location (e.g., a mile away). For safety when the system detects fire danger the tank is vented to atmosphere through an electronic valve 801, through a release pipe (e.g., six feet long) with a rain cap to prevent dirt and dust from entering. If 801 were released the gas would instantly become nonvolatile, as Oxyhydrogen Gas is very light gas, and rapidly dissipates from its fuel state into nonvolatile humidity when vented to the atmosphere.

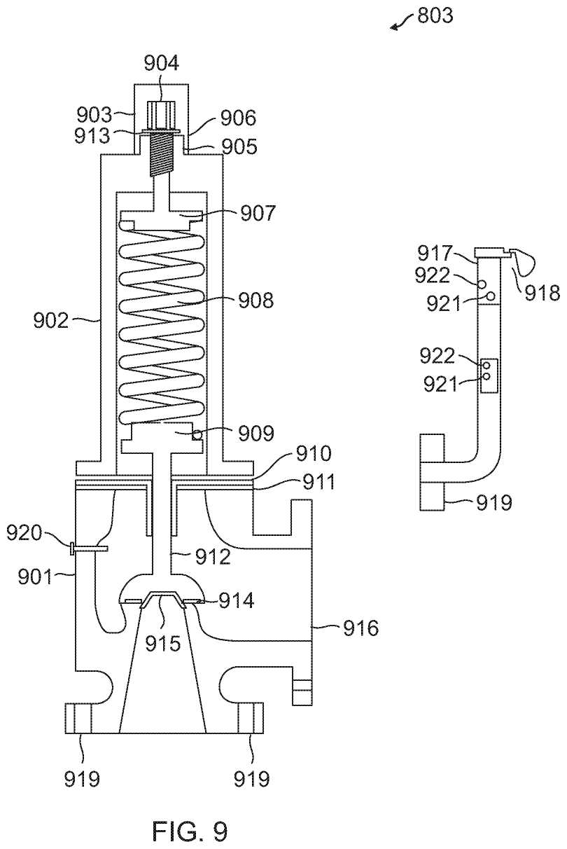

The storage tank 110 is designed and made from materials that can withstand high pressure. The ends of the tank are bell or dome shaped in an embodiment. In the event of internal ignition in the storage tank the Pressure Relief Valve 803 or valves 803. See FIG. 9 for details of an embodiment of a Custom Pressure Relief Valve that would open releasing pressure from the tank. (The amount of valves required depend on the volume of the storage tank).

This internal ignition can leave behind residual moisture and pressure in the tank therefore a drain valve 802 located at the bottom of the tank will be opened to release the residual moisture and pressure. In an embodiment, this is an automated sequence handled by the control module and sensors located on the storage tank 110. This process triggers a maintenance notification event that prompts personnel to identify and correct any problems in the system that caused the event. Once corrected the Control module would initiate a new startup sequence.

There are other ports beside the inlet 804 and outlet 805 port on the storage tank where sensor 806 monitor high/low pressure, sensor 807 monitors heat, etc. When the pressure inside the tank drops to below acceptable levels the control module will restart the production system to refill the tank to optimal pressure where the sensor will then tell the control module to shut down the production system. These sensors are all controlled by the control module.

On the Inlet port of the storage tank there is an inline flashback arrestor 810A configured to allow the Oxyhydrogen Gas to pass through it and into the storage tank. The outlet port has an electronic valve 809 that is opened by the control module to allow gas to flow through another inline flashback arrestor 810B into regulator 810C that is configured to allow the gas to leave the tank at a regulated pressure and pass through to be consumed in many different applications Oxyhydrogen Gas. Each flashback arrestor 810 may include a thermal sensor 811.

### Pressure Relief Valve 803

The Pressure Relief Valve 803 is shown in FIG. 9 in an embodiment. The Lower Valve Body 901 is made of high-grade stainless steel, or plated metals which are corrosion and hydrogen embrittlement resistant. While the upper body 902 can be made of lower grade metals such as aluminum or stainless steel since it is not exposed to the Oxyhydrogen Gas.

The Dust Cap 903 can be made from any UV resistant material as it serves to keep dust and water from entering the adjustment area. The Dust Cap has Threads 906 and is sealed by an O-ring seal 905. When the Dust Cap is Removed access to the Threaded Pressure Adjustment Bolt 904 is provided. The Pressure Adjustment Bolt 904 is screwed in or out to apply more or less pressure on the Top Spring Retainer 907, which applies force to the actual Spring 908, once the pressure is set the threaded adjustment bolt is locked in place to prevent changes in adjustment by the Lock Nut 913. Below the Spring is the Bottom Spring Retainer 909, The Bottom Spring Retainer is threaded in the center so it can be screwed onto the Plunger Rod 912.

The Plunger Rod 912 is held in alignment with the Valve Seat below by the Alignment Plate 910, and the Alignment Plate910 is sealed from outside elements by a hardened high-density seal 911.

At the bottom of the Plunger Rod 912 are two components, (1) the Seal 914 which is made of high density high temperature material such as hardened rubber, high temperature silicone, or other forms of high temperature materials and is held in place by a grove in the seat area of 912, and (2) a Heat Deflection Plate 915 that directs heat away from the Seal in the event of a release. The Deflection Plate 915 deflects the fire from a flashback event away from the seal to prevent damage to the seal, allowing the system to close up on a non-damaged seal. The Deflection Plate 915 is secured to the Plunger Rod 912 with a bolt and washer, or other form of fastening device. If a release occurs the pressure is vented through the exit port 916 to an exhaust pipe 917 which is aimed upward, away from people, animals, or structures. The Exhaust Pipe 917 is sealed by a rain cap 918.

If the pressure relief valve 803 were to be used in a liquid environment, then Exhaust Pipe 917 would be different, and may be routed down and to a storage vessel, or other drainage system. Inside the exhaust pipe there may be a filter material 921 added to manage noxious gases, or hazardous liquids. The filter material may be inserted in the top and held in place by the vent cap, or it could be accessed through a gasket-ed access on the side of the pipe. There is a sensor in the filter materiel 922 to notify the control module that the filter needs to be changed.

The different sections of the Pressure Relief Valve 803 along with its mounting are assembled by Bolts through the assembly holes in the flanges 919. The Pressure Relief Valve 803 is equipped with a sensor 920 that will notify the Control Module if a release occurs.

The Pressure Relief Valve 803 improves upon prior designs because it is designed for use with Oxyhydrogen gas or any application where a hot gas or liquid, or flame may be released because of our seal, heat deflection plate, and material construction. In the exhaust pipe or liquid release pipe a filter materiel may be added to filter out any noxious gases or hazardous liquids. The device can be monitored and managed.

### Point of Usage Control & Purge Valve 112

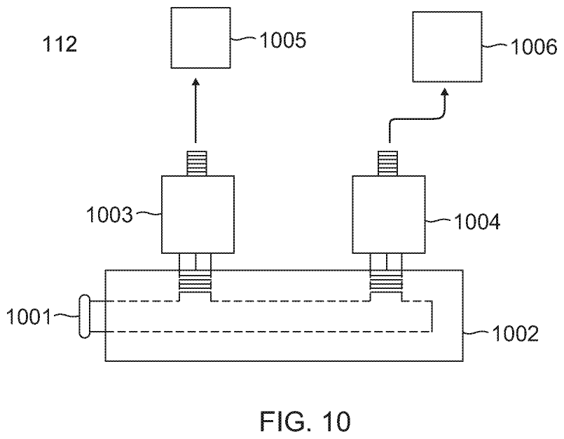

The Point of Usage Control and Purge Valve 112 is located at the very end of the system called the point of usage and is illustrated in FIG. 10. Its purpose is to pull a vacuum on the entire system, and to remove atmospherics pollution or contamination to eliminate NOX and other pollutants. In an embodiment, oxyhydrogen gas supplied to a burner or combustion module may be ignited using a high-voltage ignition system. Ignition voltage may typically range from approximately 5,000 volts to approximately 18,000 volts depending on the burner configuration and electrode spacing. Oxyhydrogen combustion produces a flame temperature of approximately 2800 degrees Celsius (approximately 5000 degrees Fahrenheit) under stoichiometric conditions. The energy content of oxyhydrogen gas may be approximately 325 BTU per cubic foot. Burner assemblies may be constructed from materials capable of withstanding high temperatures including stainless steel, nickel alloys, tool steel, titanium, copper, or aluminum. Heat dissipation rods or flame contact components may be constructed from tungsten or tungsten alloys or other materials capable of withstanding temperatures approaching 2800 degrees Celsius.

Gas flow through the burner may vary depending on the heating application and burner design. In some embodiments small appliances may require only a few cubic feet of oxyhydrogen gas per day, while larger heating systems or industrial burners may consume substantially larger volumes of gas to generate tens of thousands or millions of BTUs of thermal energy depending on the size and configuration of the burner assembly 1002. It consists of Inlet 1001, and two valves, the system purge 1003, and Oxyhydrogen Gas outlet valve 1004. These valves can be either AC or DC depending on the application.

The inlet 1001 serves a dual purpose, to allow the entire system to be vacuumed down through purge valve 1003, and to accept Oxyhydrogen Gas from the system during operation to supply Oxyhydrogen Gas to the outlet valve 1004. The inlet 1001 is connected through an inline Flashback Arrestor 111 or IFA coming from the storage tank 110.

At system startup the control module will open the purge valve 1003 and activate the pump 1005 to vacuum the entire system down all the way back to the reservoir. Once vacuum is achieved, the control module closes the purge valve 1003, and then turns off the system purge vacuum pump 1005.

The second valve is the Point of Usage Valve 1004. This valve (when energized) releases Oxyhydrogen Gas from the storage tank through the regulator to the point of usage control valve 1004 via Manifold connection 1006 and on to the actual end use consumption device. The point of use control valve 1004 is located as close as possible to the actual consumption point of the device in an embodiment in order to reduce delays in ignition time, as well as reduced extinguishing time.

This valve 1004 may be controlled by the control module if it is programmed to do so with the appropriate sensors in place, etc. or, it can be controlled by the end point of consumption device produced by various manufacturers as long as their product has a Point of Usage Control & Purge Valve with a vacuum pump that is configured to communicate with the system.

### Electrolyte Supply System

The electrolyte supply system 113 illustrated in FIG. 11 is activated by a set of sensors 1103 located on Reservoir System 102 that monitor the level of concentrate through the Control Module. The Electrolyte supply System 113 is a vessel 1100 made of a corrosive resistant material such as PVC, or Acrylic, and serves as the mixing and storage tank for the concentrated electrolyte solution. In an embodiment, it is a flat bottom tank so that a magnetic stirrer 1104 can be used to keep the solution well mixed. The distilled water and electrolyte will be injected automatically into the mixing tank to make an ideal mix through inlets 1106 and 1107 based off of input from sensors 1101 for level, and 1102 and 1103 for solution concentration mix. Electrolyte Concentration Sensors 1103 in the Reservoir System 102 are monitored by the Control Module for concentration level. In the event the concentrated solution becomes diluted an added electrolyte process is activated by the Control Module.

A pump is used to pump the solution from the Electrolyte supply system 113 to the Reservoir System 102. In an embodiment, the pumps in the Oxyhydrogen Gas production process are sealed positive displacement pumps made from corrosion resistant material. Pumps may use magnetic or peristaltic methods, for example.

### Electrolyte Recycling System

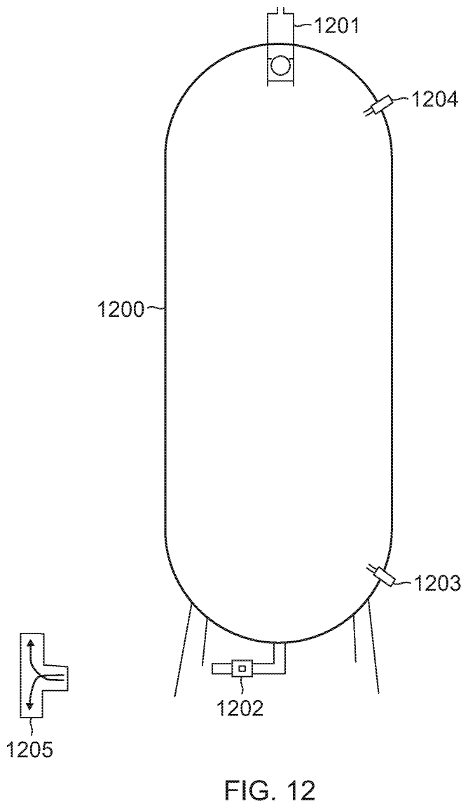

The Electrolyte Flush System 101 shown in FIG. 1 is used to transfer used electrolyte to a recycle system described in an embodiment herein in conjunction with FIG. 12. The electrolyte solution is a mix of distilled water and electrolyte; the Electrolyte Recycle System is an automated system that manages the electrolyte solution after it breaks down and needs to be replaced with fresh distilled water and electrolyte.

The recycling system consists of a large storage vessel 1200 made of various materials such as schedule 80 PVC, or other polymers, high grade stainless steel, or plated metals which are corrosion and hydrogen embrittlement resistant. In an embodiment, it has a ball valve vent 1201 at the top to prevent leakage or overflow but allow for air to enter so the contents can be drained through the drain valve 1202 at the bottom where the vessel can be emptied. There may be applications where several tanks are used depending on the size of the system. If the tank becomes full, the ball valve floats to the top to prevent overflow.

The tank 1200 is equipped with sensors for Low level 1203 and High level 1204, the high level triggers a switch from the filled tank to another tank through an optional diversion valve 1205. At this time, a message/s is sent to personnel that the first tank needs to be emptied.

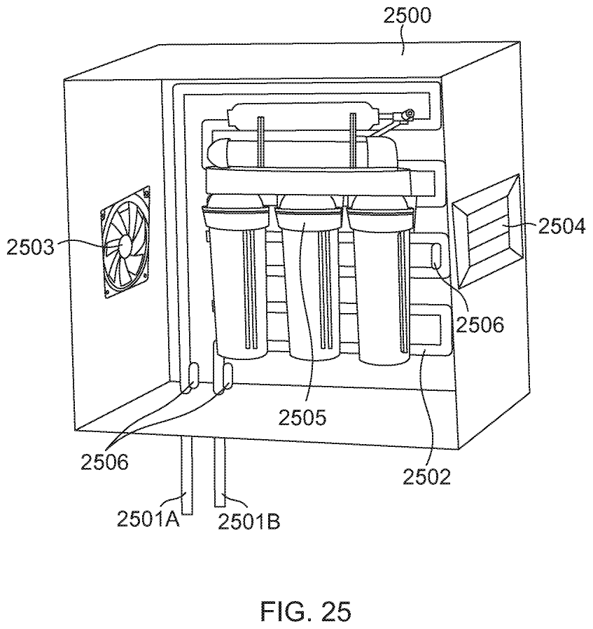

The Control Module will initiate a system dump operation which will open the Electrolyte Solution Purge Vent on the Reservoir 102, and open a valve on the Electrolyte Flush System 101. Once the Electrolyte Flush System 101 is activated the control module will turn on a pump, which is either an ac or dc pump that will send all the used Electrolyte Solution from the reservoir 102 to the electrolyte recycling tank 1200 where it can be picked up and taken to be recycled into fertilizer, soap, or other application where hydrogen enriched effluent can be used. In an embodiment, the used Electrolyte Solution may be sent to the RO System described in FIG. 25.

### Electrolyte Cooling System 114

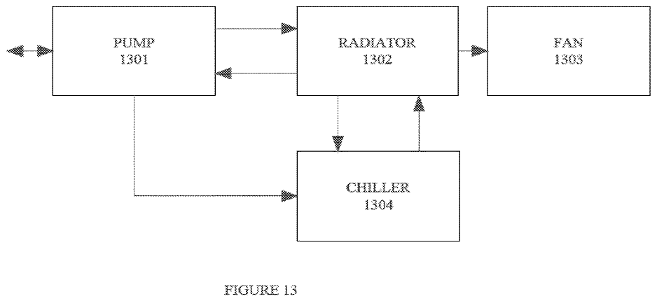

The purpose of the Cooling System 114 is to maintain a proper range of temperature in the electrolyte system. Heat is a byproduct of creating Oxyhydrogen Gas through the electrolysis process. The heat will continue to rise above the boiling point, and over temperature steaming electrolyte causes excessive moisture and impurities in the Oxyhydrogen Gas. The cooling system 150 is shown in an embodiment in FIG. 13. A pump 1301 brings electrolyte into the cooling system and returns it to the Reservoir 102. The pump is an AC or DC pump connected to an outlet port of the Reservoir System 102 and in some cases a second pump induces effluent such as glycol into a double walled commercially available radiator 1302 and then back thru a heat exchanger or chiller 1304. A fan 1303 pushes air through the radiator fins to cool the glycol effluent passing through internal tubes of the double walled radiator 1302. In an embodiment, the chiller could be driven by the heat of the radiator, providing heat recovery.

### Control Module 1500

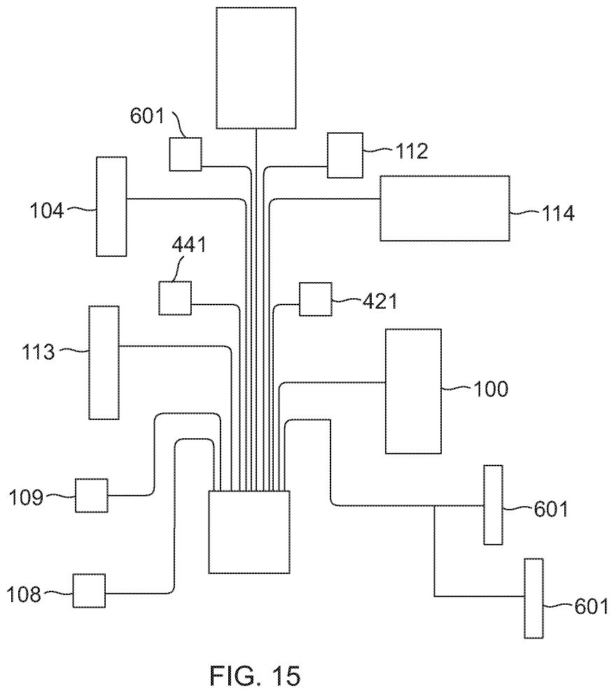

The control module 1500 is illustrated in the block diagram of FIG. 15 Each function of the Oxyhydrogen System is automated and managed with feedback coming from sensors associated with each component, including Desiccant Dryers 601, Gas Compressor 108, Generator/Electrolyzer 100, IFA 109, Electrolyte Supply 113, De-Foamer 441, Bubbler/Cooler 103, Cooling System 114, Point of Usage 112, and Reservoir 102, and the like. In an embodiment, the Control Module 1500 controls devices such as level sensors, temperature sensors, pressure sensors, flow sensors, flashback arrestors, current sensors, voltage sensors, resistance sensors, output sensors, use sensors, etc., as required.

Each sensor, probe, valve, injector, pump, (any device that has a function in the Oxyhydrogen System will be in communication with the Control Module 1500. In an embodiment, each component throughout this automated system will have a mod-buss address, or IP address, or other distinguishing identifier in the automation system so it can communicate VIA RS 485 Shielded Cabling, Twisted Pair, USB, using mod-buss registers and protocol.

The system will be able to fine tune itself VIA A.I. (Artificial Intelligence) to enhance performance and power usage during production of the Oxyhydrogen Gas as well as the usage of the Oxyhydrogen in some devices.

In an embodiment, the Control Module may include one or more machine learning or artificial intelligence algorithms configured to optimize operation of the oxyhydrogen production system. The algorithms may receive inputs from sensors distributed throughout the system, including temperature, pressure, flow rate, electrolyte condition, production rate, and environmental conditions such as elevation and atmospheric characteristics. Based on these inputs, the Control Module may dynamically adjust system parameters in real time to maintain or increase production efficiency.

In an embodiment, the Control Module may implement adaptive learning algorithms configured to analyze historical and real-time operational data collected from the system. The adaptive learning algorithms may identify patterns associated with system performance and adjust operating parameters to improve efficiency, stability, and output of the oxyhydrogen production process.

In an embodiment, the Control Module may implement predictive maintenance algorithms configured to monitor sensor data before, during, and after operational events. The predictive maintenance algorithms may identify conditions indicative of potential component degradation or failure and generate recommendations or automatically initiate preventative maintenance actions to reduce downtime and extend system lifespan.

In an embodiment, the Control Module may communicate with external or end-use devices using one or more communication protocols to coordinate system operation beyond the production system. For example, the Control Module may interface with external monitoring or control systems to optimize overall system performance across production, storage, and utilization components.

In an embodiment, outputs of the artificial intelligence or machine learning algorithms may include automatic adjustment of system parameters including, but not limited to, production rate, electrolyte concentration, temperature control, pressure levels, flow rates, and operational timing of system components.

Additional Communication. The Control module has the ability to communicate with end all end use devices to allow them know if the system is ready for use, so they can be granted permission to request Oxyhydrogen Gas from the system. When an end use device Proprietary or third party makes a request for Oxyhydrogen gas, the Control Module 1500 will receive a status update from the requesting end use device. Once the Control Module 1500 gets an OK/Ready indicating that the requesting device is purged and ready (for first time) or (ready for a relight with no power failures detected) the Control Module 1500 will allow the end use device to open its Point of Use Valve and receive fuel.

The Control Module 1500 software includes information and emergence access control to authorized personnel through mobile applications compatible with Android, Apple, PC, Mac, etc. The system is designed for safety and to simplify and automate the production and use of Oxyhydrogen Gas.

A Control Module that may be used with the system is described in U.S. patent application Ser. No. 17/979,696 filed on Nov. 2, 2022, which is incorporated by reference herein in its entirety.

### Multi-Device Distribution Manifold 1600

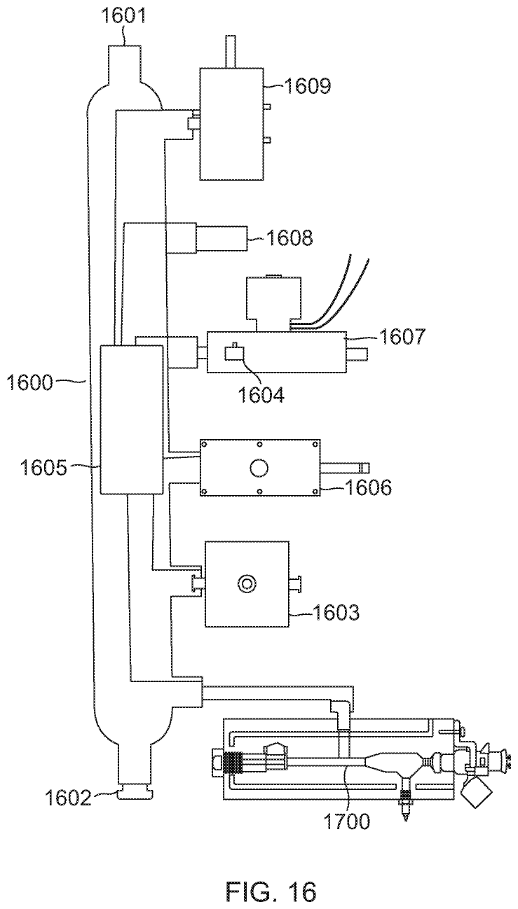

In an embodiment, the system may be used to provide oxyhydrogen to a plurality of devices, using a Mult-Device Distribution Manifold 1600 as shown in FIG. 16.

The Manifold 1600 has an inlet 1601 that receives Oxyhydrogen gas from the outlet port of the Point of Usage module. The Manifold 1600 fills with Oxyhydrogen gas and can distribute Oxyhydrogen gas out to each device through various valves and devices that are controlled by the actual end use device. Example include rotating valve 1603, sliding valve 1606, valve 1604 (with AC/DC control 1607) vacuum release 1608, Piston 1609, engine 1700, and the like. In an embodiment, each valve or device on the Manifold 1600 is connected to a Mod-Bus Bridge/Repeater 1605 that communicates with the Control Module 1500 to send valve status and information to and from each additional (Manifolds) Bridge/Repeater, as well as the Point of Usage Control & Purge Valve located on the actual end use devise. Several (Manifolds) can be connected together by adding a second, third, fourth, etc. Manifold to the expansion port 1602 and plugging in a communication jumper cable to and from each (Manifolds) Bridge/Repeater.

Any end use device made by other manufacturers in an embodiment must be equipped with its own Point of Usages Control & Purge Valve and its own small vacuum pump 1604. The manufactured system implements Mod-bus communication or other forms of communication such as TCP/IP or other protocol, compatible with systems protocols so it can send a command to open or close the valve it is connected to on the Manifold.

### System Devices

In an embodiment, the system can generate oxyhydrogen that can be used to power a number of devices. These devices include engines, burners, heat exchangers, steam turbines, filtrations systems and the like.

### Zero Compression Oxyhydrogen Engine

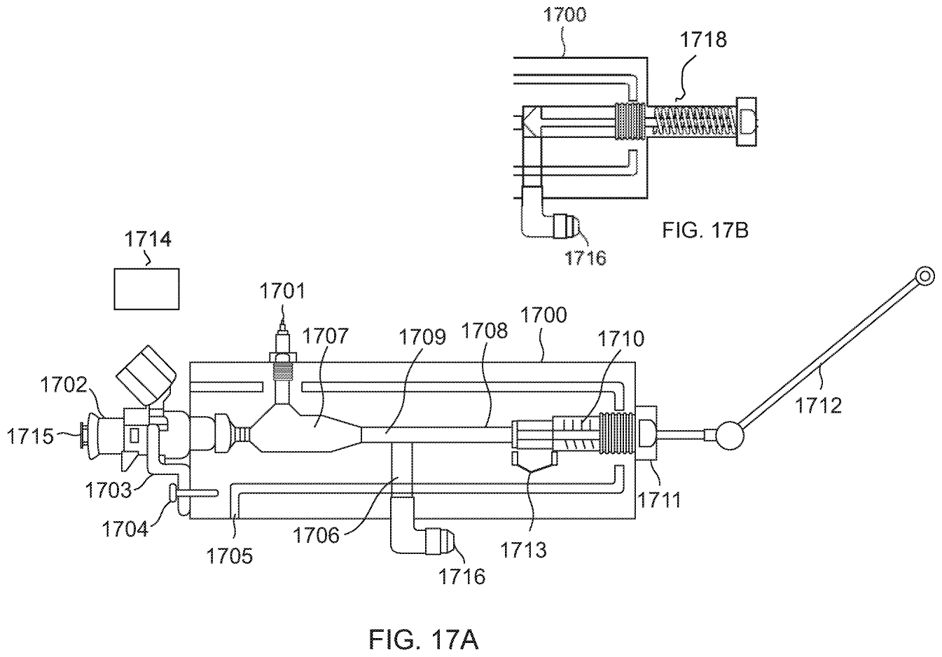

A Zero Compression Oxyhydrogen Engine 1700 illustrated in FIG. 17A and B is very different from conventional two stroke, or four stroke engines. It does not require Reed valves like a two-stroke engine, and it does not require heavy valve springs like those found in a four-stroke engine. It also does not require the extreme energy wasting compression stroke, which is the main reason that both two, and four stroke engines operate at such low efficiency ratings. It is a fact that current two and four stroke engines of today are less that 30 percent efficient.

The present Zero Compression Oxyhydrogen Engine (may) only have a low strength Return Spring 1710 used to return the Pressure Release Piston 1709 in the event the engine is used as a standalone source for making heat and steam. The Spring is not used if the Pressure Release Piston is connected to a crank shaft on a turbine or another form of Rotating apparatus through the Coupling Rod 1712. The Pressure Release Piston 1709 slides in and out through the Pressure Release Piston Sleeve 1708.

The actual Pressure Release Piston and the Return Spring (if used) is held in place by the Pressure Release Piston Bushing 1711. The Zero Compression Oxyhydrogen Engine works as follows. Oxyhydrogen gas is fed to the inlet 1715 of the Direct Injector 1702 (held in place by bracket 1703 and screw 1704). The Injector 1702 gets a command from the Engine Control Module (ECM) 1714 to activate and inject a pulse of Oxyhydrogen Gas in the Detonation Chamber 1707, after the pulse ends, and almost simultaneously the ECM sends a high voltage electrical impulse to The Detonation Exciter 1701.

The Detonation Exciter initiates the Detonation of the previously injected Oxyhydrogen Gas. Upon Detonation the Oxyhydrogen gas creates a rapid and violent expansion building pressure in the detonation chamber, this pressure is rapidly exerted onto the Pressure Release Piston forcing it outward. As the Piston is forced outward towards the end of the stroke the excess pressure which is created from the detonation of the Oxyhydrogen Gas is released out through the Exhaust Thrust Port 1706. The Pressure Release Piston acts as a valve to hold in the Oxyhydrogen Gas, and as a valve to release the pressure and moisture created from the burned Oxyhydrogen Gas after Detonation.

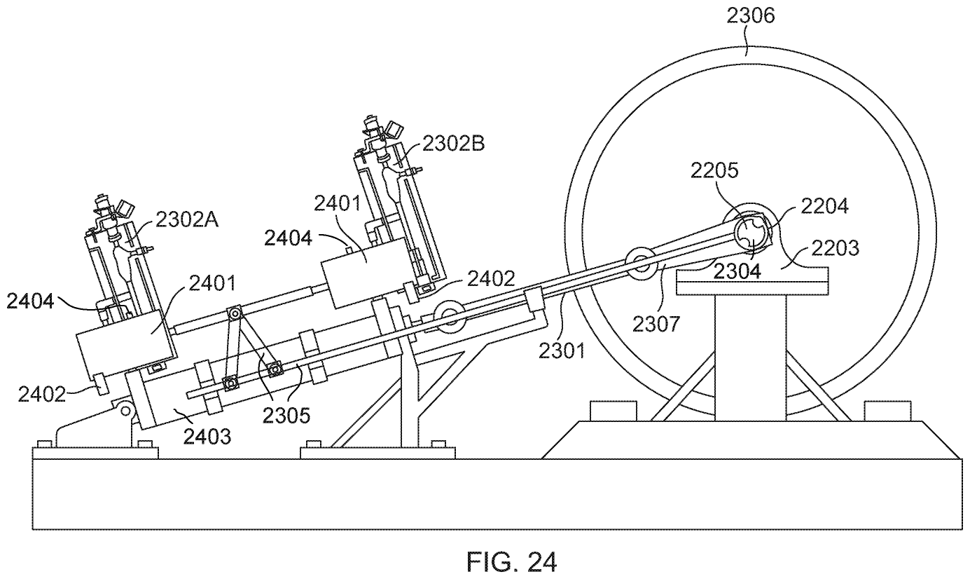

In an embodiment where the Pressure Release Piston is not used to create force, a fuel retaining valve may/will be used instead, as shown in FIG. 17B. The fuel retaining valve 1718 will screw in, in place of 1711 to replace pressure release piston 1709. Hall effects sensors 1713 would then not be used since timing reference would need to come from the powered end device such as FIG. 24. A fuel retaining valve is a valve with a face ground apposing the spring and does not operate from the mechanical forces of the engine.

After the pressure is released through the Exhaust Port it passes through the Exhaust Thrust Port Outlet 1716 which can be straight or an elbow (as shown). The elbow shown in FIG. 17A is angled towards the movement of the piston of the Zero Compression Oxyhydrogen Engine because the Exhaust Thrust created by the Detonation can also be used to assist in driving the rotation of a turbine or piston type of devised that can use pressure to preform work. The turbine receives its first energy from the forward movement of the Piston onto the Turbines Crankshaft; it then receives even more energy from Zero Compression Oxyhydrogen Engine 1700 by sending the Exhaust Thrust through tubing connected between the Exhaust Thrust Port and the Inlet Port going into the Vanes of the turbine increasing the Turbines output and the efficiency of the Engine as well.

The actual location of the Piston is tracked by the Hall Effect Sensors 1713 for when to activate the Injector and Detonation Exciter, as well as counting the Thrusts Per Minute (TPM) of the Engine. The overall work created by the Zero Compression Oxyhydrogen Engine creates the byproduct of heat. This heat is captured by the water flowing though the Water Jacket 1705 which allows for this heat around the Engine Block to be utilized for heating water, thermal storage, or anything that can use the energy from heat.

The present engine provides Higher Efficiency over modern engine designs because the intake, compression, and Exhaust strokes are not needed, as well as by using the Detonation Energy as well as the Exhaust Thrust as forms of output energy from the Engine. Another benefit is zero emissions from the Engine because no outside air is taken into the Engine to create NOX and no harmful exhaust gases because the Exhaust Thrust from the Engine is water in the form of steam. The engine is scalable for use in stationary and motive applications for generators, vehicles, aircraft, boats anywhere engines are needed.

### Oxyhydrogen Steam Reactor 1800

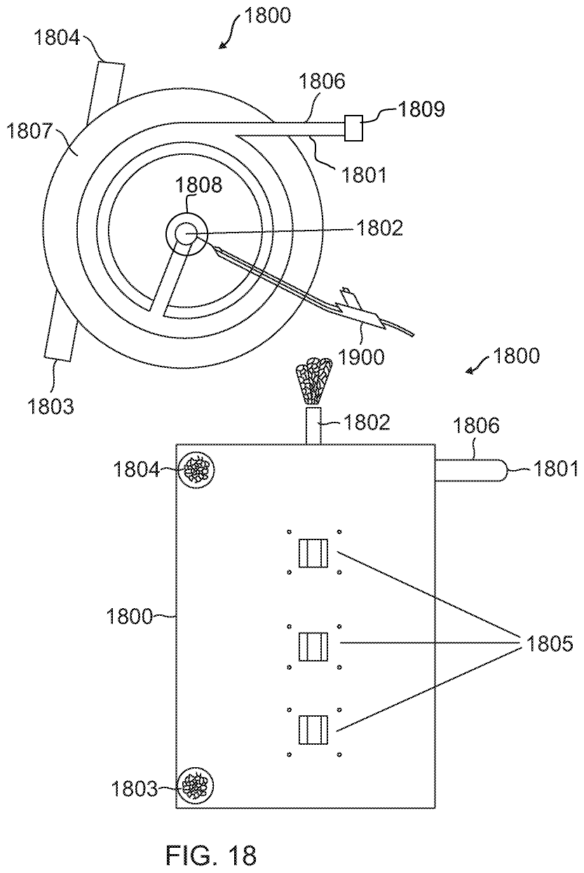

An embodiment of an Oxyhydrogen Steam Reactor 1800 is illustrated in FIG. 18. The Oxyhydrogen Steam Reactor 1800 is a scalable heating system where Deep Reach Heating Modules 1900 can be added to meet the output requirements of a given system. The Deep Reach Heating Modules 1900 mount through openings 1805 in the Outer Body of the Oxyhydrogen Steam Reactor 1800, and are positioned to make use of the extremely hot first initial tip emitted from the oxyhydrogen flame, by aligning the flame tip off center of 1802. This offset increases efficiency by creating a spiral of flame and heat between 1802 and 1808 to gather more heat as it travels upward.

Steam Reactor 1800 is designed with efficiency in mind by isolating the Deep Reach Heating Modules 1900 inside the Oxyhydrogen Steam Reactor Body to eliminate heat loss, as well as to maintain a low to no NOX burning environment, and the capturing and reuse of the created steam after it exits the device it was feeding steam to. In an embodiment, the Steam Reactor 1800 is coupled to a steam turbine but its output can be used in steam engines, turbines, industrial or domestic heat, or on anything that requires useful heat.

Water enters the inlet 1801 of a coiled Preheating Tube 1806, as shown in FIG. 18. Water passes through the coil from the top downward through flow sensor 1809 which prevents ignition of burner/s without water flow present, until it reaches the bottom where the tubing is bent to bring the tubing to the center of the Oxyhydrogen Steam Reactor Body where it connects with the Oxyhydrogen Steam Reactor Heating Tower 1802. Once the steam exits the Oxyhydrogen Steam Reactor Heating Tower 1802 it is ready to feed into the vanes of the steam turbine. The remaining heat and steam that exits the steam turbine is then captured and sent back to the body of the Oxyhydrogen Steam Reactor at the Steam Inlet 1804. The steam passes around the Steam Chamber 1807 in the outer ring of the body where some of the remaining heat is transferred into the Water Preheating Tube 1806, the remaining steam and heat is discharged through the Steam Outlet port 1803 where it can be collected for other use. The tower uses multiple Deep Reach Heating Modules to maximize the BTUs generated by the system.

### Deep Reach Heating Module 1900

The Deep Reach Heating Module 1900 solves the problem of overheating delicate components like gas valves, seals, wires, sensors, fuel lines, and the like. Oxyhydrogen is able to burn in an enclosed firebox without a vent. In an embodiment, a vent is proved at the bottom area for the purpose of releasing pressure caused from steam from the creation of water from the burn. It is helpful to have a burner that is designed to allow for Deep, or Long Reach to the inter-firebox area of a device where the delicate components can be located externally of the intense heat in the firebox.

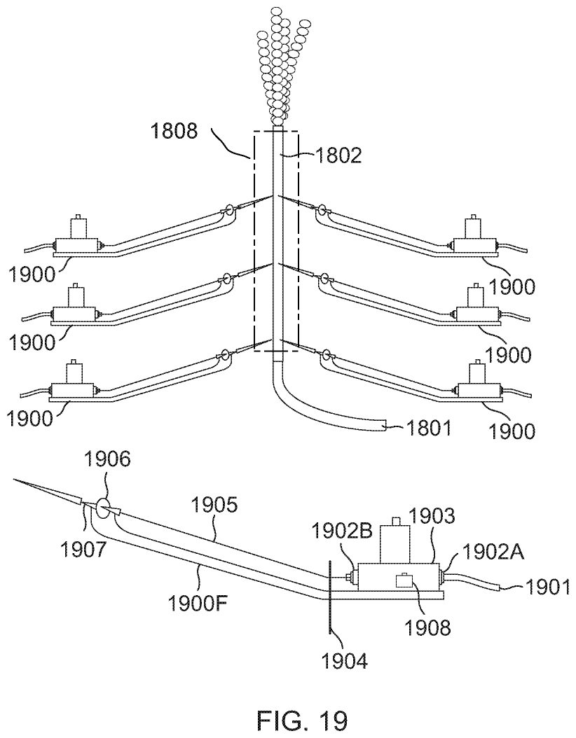

The Deep Reach Heating Module 1900 of FIG. 19 is made up of a base frame 1900F that can be made in virtually any shape or length required to locate the Oxyhydrogen flame where desired. This base frame 1900F has a Mounting Plate 1904 that can be adaptable to many applications and can be made up of many shapes and mounting holes depending on the application. The frame 1900F is also where all the components are mounted together to create a completed Deep Reach Heating Module 1900.

Components used in an embodiment to make up a Deep Reach Heating Module are an AC or DC Valve 1903 which is made of Hydrogen Embrittlement resistant material. Valve Body 1903 is where the Fuel Line 1901 connects to the Valve on Inlet Port 1902A, and an Outlet Port 1902B, as well as a Mod-Buss connector, or other form of data communication 1908. The output port 1902B is connected to Capillary Tube 1905 which passes the Oxyhydrogen Gas to the Orifice/Igniter 1907 which rests in an Insulator 1906. The Deep Reach Heating Module 1900 can be used in various Industrial. Commercial, and Residential applications such as Hot Water Heater, Steam Creation, Furnace/Heating source, Clothes Dryers, Cooking, or any application that requires a heat source.

As Shown in FIG. 19, a plurality of Deep Reach Heating Modules can be used in an array to heat water entering 1801 in the preheating tube 1806 to produce steam at outlet 1802.

### Burner System

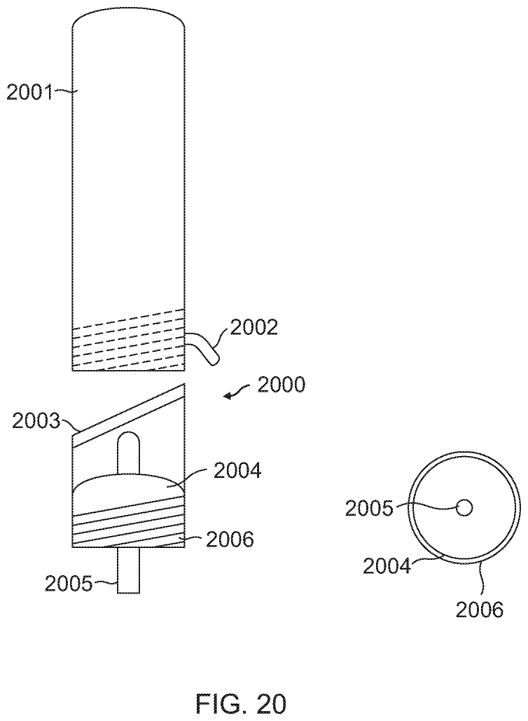

The Burner System shown in FIG. 20 is a multi-function part, consisting of a Combustion Chamber 2001, and a Drain Tube 2002 to release moisture. Drain Tube 2002 may be located at different positions on the Burner System depending on the orientation of the burner system. The Drain Tube 2002 should be at the lowest point to ensure that water is drained out properly. The Combustion Chamber 2001 provides a clean burn of the oxyhydrogen gas. The design is ultra efficient because it allows for the capture and use of nearly 100% of the heat created. This can be accomplished because an Oxyhydrogen Gas flame does not require a vent for outside air to enter in order to sustain a flame in an enclosed area. therefore, any heat created in our burner system is captured for use.

This method of burning inside of an enclosed chamber using the burner design described herein is efficient, and it creates outward pressure from the burn because as Oxyhydrogen Gas is consumed it reverts back to its original form of H20, H2O in a super-heated chamber turns into steam, this outward release of steam prevent air from entering, thus reducing, or eliminating NOX as no external oxygen is used. The molecular oxygen native in the oxyhydrogen gas is NOX free. This steam can be captured leaving the Drain Tube 2002 to heat water, assist in room heat, or anything that utilizes heat.

The Burner Module 2000 illustrated in FIG. 20 is a novel heat production device, which is designed to capture the most heat possible from an Oxyhydrogen Gas flame. The Burner Module consists of a Burner Frame 2006, a unique ignition system 2005 mounted in Thermal Filler 2004, a Heat Dissipation Rod 2003, and a Mod-bus connectors or other form or data communication that is controlled to the Control Module, with communication to other manufacturers device to initiate ignition, and a high voltage/high temp spark wire. The Burner may be a single burner or a multi-Burner system and may be of any desirable cross section, with one or more Heat Dissipation Rods 2003. To take advantage of the hottest point of the Oxyhydrogen Gas flame the Heat Dissipation Rod 2003 comprises Tungsten, Tungsten alloy, or another ultra-high temp alloy in an embodiment.

It is difficult to light Oxyhydrogen Gas using existing ignition systems available today such as a spark ignition used on a grill, or a glow bar ignition used in gas burning furnaces and ovens because neither the insulated ignition rod on a grill ignition system nor on the glow bar can survive exposed to the heat from Oxyhydrogen Gas path while burning. The oxyhydrogen is sparked immediately by ignition system 2005 upon exiting into the burner, without allowing time for gas buildup. The spark and gas travel together to meet the tungsten rod, which causes instant ignition The Heat Dissipation Rod 2003 is coupled to the burner frame so that heat is transferred to prevent the rod from melting at ignition.

In an embodiment, one or more Burner Systems can be disposed in a heat exchanger where a separate tank surrounds the Burner system and circulates water from in input to an output, so that the water is heated to a desired temperature and moved to where needed.

### Steam Reactor Heat Exchanger for Improved Efficiency

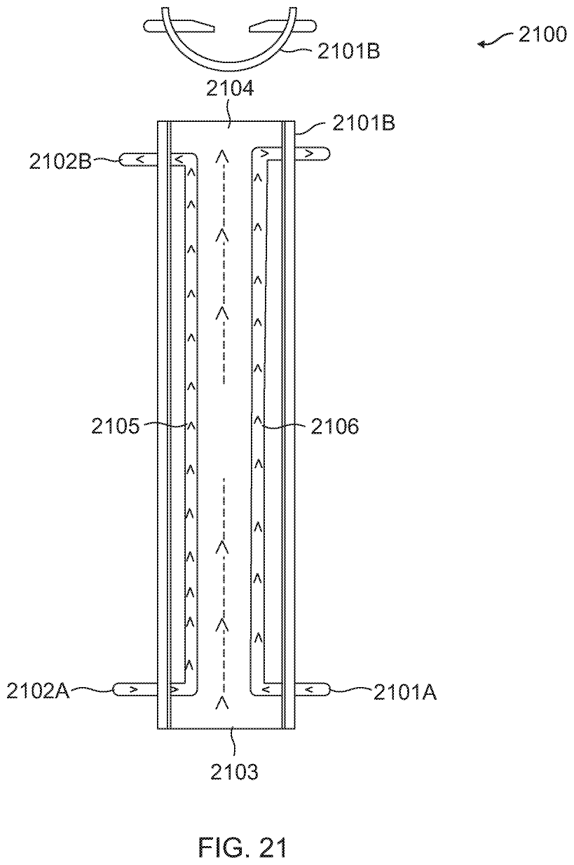

A Steam Reactor Heat Exchanger 2100 is shown in an embodiment in FIG. 21, for use with Low, Mid to High Pressure Steam applications where excess available heat remains after the steam has performed its first or second work cycle. For example, once steam exits an Oxyhydrogen Steam Reactor and enters a Steam Turbine to perform its work, as it exits the Steam Turbine there is still a great deal of heat/energy available to extract, so in an embodiment, the steam is run back through the Oxyhydrogen Steam Reactor.

The steam still has useful heat and can be provided to the Steam Reactor Heat Exchanger 2100 (moving from 2103 to 2104 in an embodiment). FIG. 21 it shows two runs of tubing being used to extract additional energy from the steam. Firstly, cold water is passed through tube 2106 from inlet 2101A to outlet 2101B where it becomes hot water and is ready to send into, for example, the Oxyhydrogen Steam Reactor where it is heated even more.

The Second tube 2105 shown running through illustrates the passing of Refrigerant through the tubing 1205 from inlet 2102A to outlet 2012B, to heat it to create a Rankine Cycle or similar cycle where a cooling cycle can be made for air conditioning, refrigeration, etc. There can be as few as one line ran through 2100, to several lines as long as there is no restriction of the flow of steam through 2100. Other lines can be added inside of 2100 for various Residential, Commercial, or Industrial applications where heat is required to perform work, such as the creation of hot water, heating, etc.

### Oxyhydrogen Steam Turbine 2200

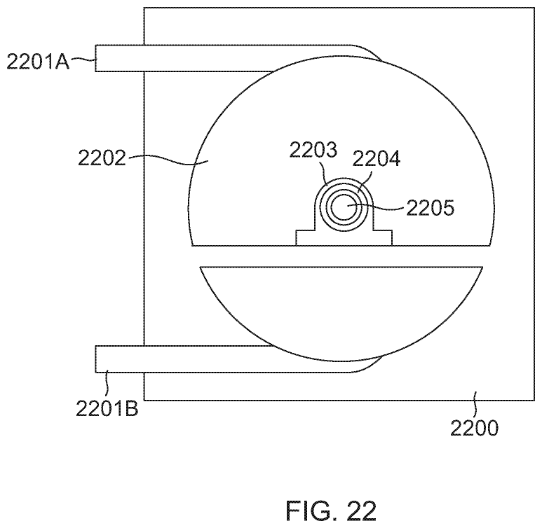

An embodiment of an Oxyhydrogen Steam Turbine 2200 is illustrated in FIG. 22 and has a highly balanced veined disc 2202 that is made of hydrogen embrittlement resistant material such as stainless steel or coated high density materials. The outer edge of the veined disc has deep grooves cut into the outer edge that resemble a comb, these groves turn the steam entering the inlet port 2201A into rotation as it passes through and over the outer veined area of the disc to the exit port 2201B. The steam that exits through the outlet port 2201B can be collected and recycled in an embodiment.

The veined disc is mounted to the main center shaft 2205. The main shaft rides on low friction bearings 2203 located on each side of the rotating disc which hold the veined disc in place. All bearings are sealed 2204 to prevent moisture entering the bearings. The rotational force exerted on the output shaft 2205 from the spinning of the veined disc can be used to run many different devices such as generators, air or water pumps, mill-write work, or any work that can be performed from a rotating shaft.

### Combination Oxyhydrogen Combustion Steam Turbine 2300

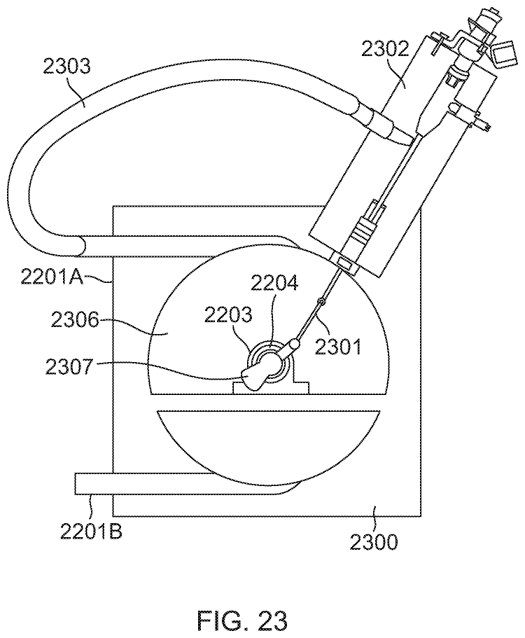

A Combination Oxyhydrogen Combustion Steam Turbine 2300 is illustrated in FIG. 23 and is unique because it not only creates power from steam and gas combustion exhaust passing over the grooved outer edge of the heavy flywheel disc 2306, but also from the force exerted from the Pressure Release Piston of the Zero Compression Oxyhydrogen Engine 2302 onto the Crankshaft 2307 on the combination turbine, through the coupling rod 2301. Disc 2306 is a heavy flywheel made of hydrogen embrittlement resistant material such as stainless steel or coated high density materials. This heavy flywheel stabilizes speed and power due to its force from weight.

Additional power is extracted from the energy created by an Oxyhydrogen gas detonation in Engine 2302 out its exhaust/steam port into the exhaust tube 2303 that runs from the exhaust port of 2302 to the inlet port 2201A of the Combination Oxyhydrogen Combustion Steam Turbine 2300 to take full advantage of not only the force created from detonation in 2302, but also of the force of the steam/air produced from the detonation into the veins of the turbine, which increases efficiency of both 2302 and 2300.

FIG. 24 illustrates the combination system in an embodiment. A pair of engines 2302A and 2302 B are coupled to multiport piston valves with multiple ports 2401 and vacuum release valves 2402 to push rod 2301 via crankshaft 2307. The weighted flywheel 2306 is mounted to the main center shaft 2205. The main shaft rides on low friction bearings 2203 located on each side of the rotating disc which hold the veined disc weighted flywheel in place. All bearings are sealed 2204 to prevent moisture entering the bearings.

In an embodiment, combustion generated by a first zero compression oxyhydrogen engine 2302A is directed through valve 2401 into a rear portion of a drive piston 2403. The resulting pressure drives the drive piston 2403 forward, thereby transmitting force through push rod 2301 to rotate weighted flywheel 2306 via crankshaft 2307. During this forward stroke, a corresponding valve associated with a second zero compression oxyhydrogen engine 2302B is positioned to allow pressure to be released through vent 2404, such that a power stroke produced by the first zero compression oxyhydrogen engine 2302A occurs concurrently with an exhaust operation associated with the second zero compression oxyhydrogen engine 2302B.

At or near the end of the stroke of the drive piston 2403, a timing mechanism including timing pin 2304 coupled to shaft 2205 a slide motion (or reciprocating motion, or back and forth motion) of push rod 2305 to transition the valves for the return power stroke which actuates valve transitions. In an embodiment, the timing pin 2304 may cause one or more slide valves associated with valves 2401 to change position, or alternatively may rotate one or more rotary valves via a mechanical linkage or timing chain coupled to shaft 2205. This actuation enables combustion output from the second zero compression oxyhydrogen engine 2302B to be directed through valve 2401 into the drive piston 2403 while the first zero compression oxyhydrogen engine 2302A transitions to an exhaust state through vent 2404.

In an embodiment, when the system reaches a predetermined operational speed without load, the system may enter an idle mode in which one or both of the zero compression oxyhydrogen engines 2302A and 2302B are not actively producing combustion events. Under such conditions, opening of valves 2401 to a non-activated one of the zero compression oxyhydrogen engines 2302A or 2302B may create a vacuum condition that produces drag on the drive piston 2403. To reduce or eliminate such drag, one or more vacuum release valves 2402 associated with valves 2401 may be actuated to permit pressure equalization and allow freewheel operation of the drive piston 2403, push rod 2301, disc 2306, and crankshaft 2307. This drag force may be used as an engine brake to reduce RPM's, or to compress air into tanks, or to create useful heat, or cooling cycles.

This embodiment does not require the force of an external electro-mechanical starter. a pulse of fuel into the zero compression oxyhydrogen engine on the left, followed by a high voltage electrical impulse to The Detonation Exciter 1701 will start a repetitive chain reaction.

In an embodiment, the system reduces or eliminates intake, compression, and exhaust strokes associated with conventional internal combustion engines by utilizing alternating combustion inputs from the zero compression oxyhydrogen engines 2302A and 2302B to drive the drive piston 2403 through successive power strokes over approximately 180 degrees of rotation of the crankshaft 2307. This configuration allows a single drive piston 2403 and associated push rod 2301, disc 2306, and crankshaft 2307 to perform work that would otherwise require multiple cylinders, thereby reducing system size while maintaining output.

An embodiment including some or all components can be assembled in different ways to create a single assembly. In an embodiment, the oxyhydrogen engine 2302, could be made inside of the drive piston 2403 to include valve 2401 as an assembly creating a cylinder of an engine block or assembly. This embodiment allows a V4 engine block size that will have 8 strokes.

### Ultra Filtration/RO System With Climate Control 2500

An embodiment of Oxyhydrogen production and utilization process 2500 is illustrated in FIG. 25 and produces water due to the nature of the process some metal coatings particulate and or heavy metals are produced by the heated metals and caustic electrolyte to keep the water clean and prevent concentrating pollutants, after so many passes, the UF and or RO system cleans the water of pollutants and the by products are put into containment and recycled to industry where they can be used for useful purposes.

The Ultra Filtration and or RO System with Climate Control is contained in an insulated cabinet 2500 that can be made of stainless steel, ABS Plastic or other ridged materials. There is a run of tubing 2502 inside the cabinet for the purpose of flowing either hot or cold water through it in order to maintain an optimum temperature inside the cabinet for the hardware and the filtering elements mounted inside. There is an inlet-2501A and an outlet-2501B for water coil 2502.

In order to distribute the heating or cooling of the cabinet evenly a tube axial or other pressurizing fan 2503 in installed in the cabinet opposite of a louver system 2504 to let the air escape the cabinet. In this example the Cabinet 2500 is cooling an RO System shown as 2505, but it could be cooling an Ultra Filtration system. Sensors 2506 in the cabinet monitor water temperatures, cabinet temperatures and flows. The UF/or RO system is connected into the Oxyhydrogen Control Module, or utilization system as needed.

The Oxyhydrogen production and utilization systems creates a free floating particulate and heavy metal presence due in part to the effects of hydrogen embrittlement and the caustic electrolytes and particulate management and remediation system is necessary. The system filters out heavy metals and other pollutants. The system uses the Ultra Filtration, and RO Design with a temperature and saturation management system that keeps the filtration medium such as Charcoal, zeolite, etc. at optimum temperatures providing long life.

The system uses a recyclable filter that filters the H20 produced by the electrolysis production and combustion processes on all of systems these filters may be flat style or cartridge style in our smaller utilization systems like refrigerators, generators, and motor vehicles. The Oxyhydrogen Contaminant and heavy metal remediation system is designed as a companion for the larger production and utilization systems such as the stationary Oxyhydrogen steam engine turbine generator, or Oxyhydrogen combination steam engine turbine generator or any larger utilization device.

Thus, a method and apparatus for generating and using oxyhydrogen has been described.

1. A scalable oxyhydrogen production, storage, and conditioning system configured to process oxyhydrogen gas along a continuous flow path, comprising:
a generator configured to produce oxyhydrogen gas from an electrolyte solution using electrolysis;
a reservoir system fluidly coupled to the generator and configured to receive the produced oxyhydrogen gas and separate the oxyhydrogen gas from the electrolyte solution;
a condensing and drying system fluidly coupled to the reservoir system and configured to remove moisture from the oxyhydrogen gas;
a gas compressor fluidly coupled to the condensing and drying system and configured to compress the oxyhydrogen gas;
a storage tank fluidly coupled to the gas compressor and configured to store the compressed oxyhydrogen gas; and
at least one flashback arrestor positioned along the continuous flow path and configured to prevent flame propagation within the system.

2. The system of claim 1, wherein the generator comprises a plate-based dry cell electrolyzer having stacked plates separated by spacer gaskets.

3. The system of claim 1, wherein the generator comprises a concentric tube dry cell electrolyzer having a plurality of nested conductive tubes.

4. The system of claim 1, wherein the reservoir system includes one or more diffuser tubes configured to emit oxyhydrogen gas bubbles into the electrolyte solution.

5. The system of claim 4, wherein the diffuser tubes produce bubbles having a diameter between approximately 0.1 millimeters and approximately 1.5 millimeters.

6. The system of claim 1, wherein the condensing and drying system comprises a moisture condensing system including condensing tubing and a liquid collection tank, and one or more desiccant dryers configured to remove humidity from the oxyhydrogen gas.

7. The system of claim 6, wherein the desiccant dryers contain silica gel and are configured to regenerate under vacuum.

8. The system of claim 1, wherein the gas compressor is selected from the group consisting of reciprocating compressors, screw compressors, diaphragm compressors, piston compressors, ionic liquid compressors, and scroll compressors.

9. The system of claim 1, wherein the storage tank is configured to operate at pressures between approximately 50 PSI and approximately 3000 PSI.

10. The system of claim 1, wherein the flashback arrestor includes sensors configured to detect combustion events within the gas flow path.

11. The system of claim 10, wherein the sensors include one or more of ultraviolet sensors, infrared sensors, optical sensors, temperature sensors, pressure sensors, photodiodes, or phototransistors.

12. A method of producing and conditioning oxyhydrogen gas along a continuous processing path, comprising:
producing oxyhydrogen gas using an electrolyzer supplied with an electrolyte solution;
directing the produced oxyhydrogen gas into a reservoir system to separate the oxyhydrogen gas from the electrolyte solution;
flowing the oxyhydrogen gas from the reservoir system to a condensing and drying system to remove moisture from the oxyhydrogen gas;
flowing the oxyhydrogen gas from the condensing and drying system to a gas compressor to compress the oxyhydrogen gas;
flowing the compressed oxyhydrogen gas to a storage tank for storage; and
preventing flame propagation along the continuous processing path using at least one flashback arrestor positioned along the continuous processing path.

13. The method of claim 12, further comprising maintaining the reservoir system under vacuum.

14. The method of claim 12, further comprising regulating electrolyte temperature using a cooling system.

15. The method of claim 12, further comprising regenerating a desiccant dryer by applying vacuum to the dryer.

16. The method of claim 12, further comprising detecting flashback conditions using sensors associated with a flashback arrestor.

17. The method of claim 16, further comprising automatically shutting down the system upon detection of a flashback condition.

18. The method of claim 12, further comprising monitoring system sensors using a control module.

19. The method of claim 18, further comprising automatically adjusting electrolyte levels or concentrations based on sensor data.

20. The method of claim 12, further comprising distributing oxyhydrogen gas to a plurality of end-use devices through a distribution manifold.
